(19) United States
(12) Patent Application Publication
(10) Pub. No.: US 2023/0296559 A1
(43) Pub. Date: Sep. 21, 2023

(54) METHODS AND SYSTEMS FOR ANALYZING POLYPEPTIDE VARIANTS

(71) Applicant: Regeneron Pharmaceuticals, Inc., Tarrytown, NY (US)

(72) Inventors: Nisha PALACKAL, White Plains, NY (US); Kun LU, Scarsdale, NY (US); Gangadhar DHULIPALA, Montvale, NJ (US); Erica PYLES, New City, NY (US)

(73) Assignee: Regeneron Pharmaceuticals, Inc., Tarrytown, NY (US)

(21) Appl. No.: 18/185,624

(22) Filed: Mar. 17, 2023

Related U.S. Application Data
(60) Provisional application No. 63/269,595, filed on Mar. 18, 2022.

(51) Int. Cl. G01N 27/447

(52) U.S. Cl. CPC G01N 27/44795; G01N 27/44726

(57) ABSTRACT

A method of quantifying charge variants within an analyte may include introducing a sample buffer comprising the analyte into a capillary, separating charge variants within the sample buffer along an isoelectric gradient, incubating the capillary in a detection antibody, quantifying a relative abundance of a charge variant based on a signal that corresponds to the detection antibody. The method may further include generating an electropherogram, wherein the electropherogram includes a plot of a strength of a signal generated by a reporter molecule versus an isoelectric point along the isoelectric gradient where the signal was detected.

### CROSS-REFERENCE TO RELATED APPLICATIONS

This application claims priority to U.S. Provisional Patent Application No. 63/269,595, filed on Mar. 18, 2022, which is hereby incorporated by reference in its entirety.

### FIELD OF DISCLOSURE

The present disclosure relates to systems and methods for analyzing polypeptide variants. Some aspects of the present disclosure relate to systems and methods for quantifying charge variants within a sample.

### INTRODUCTION

Biopharmaceutical products (e.g., antibodies, antibody-drug conjugates, fusion proteins, adeno-associated viruses (AAVs), proteins, tissues, cells, polypeptides, or other therapeutic products of biological origin) are increasingly being used in the treatment and prevention of infectious diseases, genetic diseases, autoimmune diseases, and other ailments. Because of their biologic origins, biopharmaceutical products have multiple dimensions of heterogeneity, including charge heterogeneity. For example, various post translational modifications such as glycosylation, oxidation, or deamidation, can lead to charge heterogeneity among biologically produced products under similar or identical manufacturing conditions.

Conventional methods of characterizing charge variants and developing charge-variant profiles may be limited to understanding intact proteins or multi-protein structures. However, charge variants can be formed within polypeptides or protein sub-units, and characterization of the larger structures may lack the detail necessary to characterize the charge variants of individual polypeptides or sub-units.

Additionally, conventional methods of characterizing charge variants may include time and labor intensive chromatography steps that increase the cost associated with characterizing charge variants.

### SUMMARY

Aspects of the present disclosure relate to a method of quantifying a charge variant within an analyte. The method may include introducing the analyte into a capillary, separating charge variants within the sample buffer along an isoelectric gradient, incubating the capillary in a detection antibody, and quantifying a relative abundance of a charge variant based on a signal that corresponds to the detection antibody.

The method may further comprise incubating the capillary in a reporter molecule. The reporter molecule may comprise an antibody conjugated to horseradish peroxidase or streptavidin conjugated to horseradish peroxidase. The method may further comprise introducing a detection agent into the capillary.

The detection agent may be luminol-peroxide. The method may further comprise generating an electropherogram, wherein the electropherogram includes a plot of a strength of a chemiluminescent signal generated by the reporter molecule versus an isoelectric point along the isoelectric gradient where the chemiluminescent signal was detected. Quantifying the relative abundance of the charge variant based on the signal that corresponds to the detection antibody may include calculating an area under a peak of the electropherogram that corresponds to the charge variant. The method may further comprise immobilizing charge variants within the capillary, after separating charge variants along the isoelectric gradient, and prior to incubating the capillary in the detection antibody.

In another aspect, the present disclosure includes a method of quantifying a charge variant within an analyte. The method may comprise reducing and denaturing polypeptides within the analyte to generate reduced and denatured polypeptides, wherein the analyte includes charge variants of a target polypeptide. The method may further include buffer exchanging the reduced and denatured polypeptides to generate a buffer exchanged sample, wherein the buffer exchanged sample includes the reduced and denatured polypeptides. The method may further include preparing a sample buffer including the buffer exchanged sample. In some embodiments, the method includes introducing the sample buffer into a capillary, and introducing the sample buffer into a capillary. The method may further include separating charge variants of the target polypeptide along an isoelectric gradient. In some embodiments, the method includes measuring a signal that is correlated to an abundance of the target polypeptide at a region within the isoelectric gradient within the capillary.

The sample buffer may include urea, carrier ampholytes, and a cellulose. The cellulose may be hydroxyl propyl methyl cellulose, and the sample buffer may include at least approximately 1 volume percent hydroxyl propyl methyl cellulose. The sample buffer may include a urea concentration of at least approximately 6 M or at least approximately 8 M. The sample buffer may include formamide. The formamide concentration within the sample may be less than or equal to approximately 30 volume percent.

In another aspect, the present disclosure includes a method of assessing a level of environmental stress perceived by a sample of a target polypeptide. The method may include generating a charge variant profile for the sample, wherein the charge variant profile includes a plurality of peaks. Each peak of the plurality of peaks may be associated with a corresponding charge variant of the target polypeptide, associated with an isoelectric point that is equivalent to the isoelectric point of the corresponding charge variant of the target polypeptide, and/or include a relative peak area that is associated with a relative abundance of the corresponding charge variant of the target polypeptide. The method may further include comparing the charge variant profile for the sample to one or more known charge variant profiles. In some embodiments, the method includes determining a level of environmental stress perceived by the sample, based on the comparison of the charge variant profile for the sample to the one or more known charge variant profiles.

The level of environmental stress may be associated with a level of thermal stress, a level of stress due to a manufacturing process hold time, or a level of stress due to freeze-thaw cycles. The target polypeptide may include an antibody or an adeno-associated virus. Generating the charge variant profile for the sample may include introducing the sample into a capillary and separating charge variants of the target polypeptide along an isoelectric gradient. Generating the charge variant profile for the sample may further include incubating the capillary in a detection antibody, incubating the capillary in a reporter molecule, and generating an electropherogram, wherein the electropherogram includes a plot of a strength of a signal generated by the reporter molecule versus an isoelectric point along the isoelectric gradient where the signal was detected.

### BRIEF DESCRIPTION OF THE DRAWINGS

The accompanying drawings, which are incorporated in and constitute a part of this specification, illustrate various exemplary embodiments, and together with the description, serve to explain the principles of the disclosed embodiments. Any features of an embodiment or example described herein (e.g., composition, formulation, method, etc.) may be combined with any other embodiment or example, and all such combinations are encompassed by the present disclosure. Moreover, the described systems and methods are neither limited to any single aspect nor embodiment thereof, nor to any combinations or permutations of such aspects and embodiments. For the sake of brevity, certain permutations and combinations are not discussed and/or illustrated separately herein.

FIG. 1 depicts, in flow-chart form, an exemplary method for separating and quantifying charge variants of reduced and denatured polypeptides, according to aspects of the present disclosure;

FIG. 2 depicts, in flow-chart form, an exemplary method for separating and quantifying charge variants of reduced and denatured polypeptides, according to aspects of the present disclosure;

FIG. 3 depicts, in flow-chart form, an exemplary method for quantifying relative abundances of charge variants, according to aspects of the present disclosure;

FIGS. 4A and 4B depict a charge variant profile of a reduced and denatured analyte, according to aspects of the present disclosure;

FIG. 4C depicts a charge variant profile of a reduced and denatured analyte, according to aspects of the present disclosure;

FIG. 4D depicts a charge variant profile of a reduced and denatured analyte, according to aspects of the present disclosure;

FIGS. 5A and 5B depict a charge variant profile of a reduced and denatured analyte, according to aspects of the present disclosure;

FIG. 5C depicts a charge variant profile of a reduced and denatured analyte, according to aspects of the present disclosure;

FIG. 5D depicts a charge variant profile of a reduced and denatured analyte, according to aspects of the present disclosure;

FIG. 6A depicts charge variant profiles of reduced and denatured analytes, according to aspects of the present disclosure;

FIG. 6B depicts charge variant profiles of reduced and denatured analytes, according to aspects of the present disclosure;

FIG. 6C depicts a charge variant profile of a reduced and denatured analyte, according to aspects of the present disclosure;

FIG. 7A depicts a charge variant profile of a reduced and denatured analyte, according to aspects of the present disclosure;

FIG. 7B depicts a charge variant profile of a reduced and denature analyte, according to aspects of the present disclosure;

FIG. 8A depicts charge variant profiles of reduced and denatured analytes, according to aspects of the present disclosure;

FIG. 8B depicts charge variant profiles of reduced and denatured analytes, according to aspects of the present disclosure;

FIG. 9A depicts a charge variant profile of a reduced and denature analyte, according to aspects of the present disclosure;

FIG. 9B depicts a charge variant profile of a reduced and denature analyte, according to aspects of the present disclosure;

FIG. 9C depicts a plot comparing relative peak areas calculated based on the charge variant profiles of FIGS. 9A and 9B, according to aspects of the present disclosure;

FIG. 10A depicts charge variant profiles of reduced and denatured analytes, according to aspects of the present disclosure;

FIG. 10B depicts charge variant profiles of reduced and denatured analytes, according to aspects of the present disclosure;

FIG. 11A depicts charge variant profiles of reduced and denatured analytes, according to aspects of the present disclosure;

FIG. 11B depicts charge variant profiles of reduced and denatured analytes, according to aspects of the present disclosure;

FIG. 11C depicts a plot comparing relative peak areas calculated based on the charge variant profiles of FIG. 11A;

FIG. 11D depicts a plot comparing relative peak areas calculated based on the charge variant profiles of FIG. 11B, according to aspects of the present disclosure;

FIG. 12A depicts charge variant profiles of native analytes, according to aspects of the present disclosure;

FIG. 12B depicts charge variant profiles of native analytes, according to aspects of the present disclosure;

FIG. 13A depicts charge variant profiles of reduced and denatured analytes, according to aspects of the present disclosure;

FIG. 13B depicts charge variant profiles of reduced and denatured analytes, according to aspects of the present disclosure;

FIG. 14A depicts a charge variant profile of a reduced and denature analyte, according to aspects of the present disclosure;

FIG. 14B depicts a charge variant profile of a reduced and denature analyte, according to aspects of the present disclosure;

FIG. 15 depicts a western blot using anti-viral protein polyclonal antibodies, according to aspects of the present disclosure;

FIG. 16 depicts charge variant profiles of a reduced and denatured analyte, according to aspects of the present disclosure;

FIG. 17 depicts charge variant profiles of a reduced and denatured analyte, according to aspects of the present disclosure;

FIGS. 18, 19, 20A, 20B, 21A, 21B, 22A, 22B, 23A-23C, 24A-24D, 25A-25D, and 26A-26D each depict a charge variant profile of a reduced and denatured analyte, according to aspects of the present disclosure;

FIG. 27A depicts charge variant profiles of a reduced and denatured analyte, according to aspects of the present disclosure;

FIG. 27B depicts charge variant profiles of a reduced and denatured analyte, according to aspects of the present disclosure;

FIGS. 28A-28E each depict a charge variant profile of a reduced and denature analyte, according to aspects of the present disclosure;

FIG. 29 depicts a plot comparing relative peak areas calculated based on the charge variant profiles of FIGS. 28A-28E, according to aspects of the present disclosure;

FIGS. 30A-30D each depict a charge variant profile of a reduced and denature analyte, according to aspects of the present disclosure;

FIG. 31 depicts a plot comparing relative peak areas calculated based on the charge variant profiles of FIGS. 30A-30D, according to aspects of the present disclosure;

FIGS. 32A, 32B, 33A, 33B, 34A, and 34B each depict a charge variant profile of a reduced and denature analyte, according to aspects of the present disclosure; and

FIGS. 35, 36, and 37 depict charge variant profiles of a reduced and denature analyte, according to aspects of the present disclosure.

### DETAILED DESCRIPTION

Unless defined otherwise, all technical and scientific terms used herein have the same meaning as is commonly understood by one of ordinary skill in the art to which this disclosure belongs. Although any suitable methods and materials (e.g., similar or equivalent to those described herein) can be used in the practice or testing of the present disclosure, particular example methods are now described. All publications mentioned are hereby incorporated by reference.

As used herein, the terms “comprises,” “comprising,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. The term “exemplary” is used in the sense of “example,” rather than “ideal.” For the terms “for example” and “such as,” and grammatical equivalences thereof, the phrase “and without limitation” is understood to follow unless explicitly stated otherwise.

As used herein, the term “about” is meant to account for variations due to experimental error. When applied to numeric values, the term “about” may indicate a variation of +/−5% from the disclosed numeric value, unless a different variation is specified. As used herein, the singular forms “a,” “an,” and “the” include plural referents unless the context clearly dictates otherwise. Further, all ranges are understood to be inclusive of endpoints, e.g., from 1 centimeter (cm) to 5 cm would include lengths of 1 cm, 5 cm, and all distances between 1 cm and 5 cm.

It should be noted that all numeric values disclosed or claimed herein (including all disclosed values, limits, and ranges) may have a variation of +/−5% from the disclosed numeric value unless a different variation is specified.

The term “polypeptide” as used herein refers to any amino acid polymer having more than about 20 amino acids covalently linked via amide bonds. Proteins contain one or more amino acid polymer chains (e.g., polypeptides). Thus, a polypeptide may be a protein, and a protein may contain multiple polypeptides to form a single functioning biomolecule.

Post-translational modifications may modify or alter the structure of a polypeptide. For example, disulfide bridges (e.g., S—S bonds between cysteine residues) may be formed post-translationally in some proteins. Some disulfide bridges are essential to proper structure, function, and interaction of polypeptides, immunoglobulins, proteins, co-factors, substrates, and the like. In addition to disulfide bond formation, proteins may be subject to other post-translational modifications, such as lipidation (e.g., myristoylation, palmitoylation, farnesoylation, geranylgeranylation, and glycosylphosphatidylinositol (GPI) anchor formation), alkylation (e.g., methylation), acylation, amidation, glycosylation (e.g., addition of glycosyl groups at arginine, asparagine, cysteine, hydroxylysine, serine, threonine, tyrosine, and/or tryptophan), and phosphorylation (i.e., the addition of a phosphate group to serine, threonine, tyrosine, and/or histidine). Post-translational modifications may affect the hydrophobicity, electrostatic surface properties, or other properties which determine the surface-to-surface interactions participated in by the polypeptide.

As used herein, the term “protein” includes biotherapeutic proteins, recombinant proteins used in research or therapy, trap proteins and other Fc-fusion proteins, chimeric proteins, antibodies, monoclonal antibodies, human antibodies, bispecific antibodies, antibody fragments, antibody-like molecules, nanobodies, recombinant antibody chimeras, cytokines, chemokines, peptide hormones, and the like. A protein of interest (POI) may include any polypeptide or protein that is desired to be isolated, purified, or otherwise prepared. POIs may include polypeptides produced by a cell, including antibodies.

The term “antibody,” as used herein, includes immunoglobulins comprised of four polypeptide chains: two heavy (H) chains and two light (L) chains inter-connected by disulfide bonds. Typically, antibodies have a molecular weight of over 100 kDa, such as between 130 kDa and 200 kDa, such as about 140 kDa, 145 kDa, 150 kDa, 155 kDa, or 160 kDa. Each heavy chain comprises a heavy chain variable region (abbreviated herein as HCVR or VH) and a heavy chain constant region. The heavy chain constant region comprises three domains, CH1, CH2 and CH3. Each light chain comprises a light chain variable region (abbreviated herein as LCVR or VL) and a light chain constant region. The light chain constant region comprises one domain, CL. The VH and VL regions can be further subdivided into regions of hypervariability, termed complementarity determining regions (CDR), interspersed with regions that are more conserved, termed framework regions (FR). Each VH and VL is composed of three CDRs and four FRs, arranged from amino-terminus to carboxy-terminus in the following order: FR1, CDR1, FR2, CDR2, FR3, CDR3, FR4 (heavy chain CDRs may be abbreviated as HCDR1, HCDR2 and HCDR3; light chain CDRs may be abbreviated as LCDR1, LCDR2 and LCDR3.

A class of immunoglobulins called Immunoglobulin G (IgG), for example, is common in human serum and comprises four polypeptide chains—two light chains and two heavy chains. Each light chain is linked to one heavy chain via a cystine disulfide bond, and the two heavy chains are bound to each other via two cystine disulfide bonds. Other classes of human immunoglobulins include IgA, IgM, IgD, and IgE. In the case of IgG, four subclasses exist: IgG 1, IgG 2, IgG 3, and IgG 4. Each subclass differs in their constant regions, and as a result, may have different effector functions. In some embodiments described herein, a biopharmaceutical product may comprise a target polypeptide including IgG. In at least one embodiment, the target polypeptide comprises IgG 4.

The term “antibody,” as used herein, also includes antigen-binding fragments of full antibody molecules. The terms “antigen-binding portion” of an antibody, “antigen-binding fragment” of an antibody, and the like, as used herein, include any naturally occurring, enzymatically obtainable, synthetic, or genetically engineered polypeptide or glycoprotein that specifically binds an antigen to form a complex. Antigen-binding fragments of an antibody may be derived, e.g., from full antibody molecules using any suitable standard techniques such as proteolytic digestion or recombinant genetic engineering techniques involving the manipulation and expression of DNA encoding antibody variable and optionally constant domains. Such DNA is known and/or is readily available from, e.g., commercial sources, DNA libraries (including, e.g., phage-antibody libraries), or can be synthesized. The DNA may be sequenced and manipulated chemically or by using molecular biology techniques, for example, to arrange one or more variable and/or constant domains into a suitable configuration, or to introduce codons, create cysteine residues, modify, add or delete amino acids, etc.

Biopharmaceutical products (e.g., target molecules, polypeptides, antibodies) may be produced using recombinant cell-based production systems, such as the insect bacculovirus system, yeast systems (e.g., Pichia sp.), or mammalian systems (e.g., CHO cells and CHO derivatives like CHO-K1 cells). The term “cell” includes any cell that is suitable for expressing a recombinant nucleic acid sequence. Cells include those of prokaryotes and eukaryotes (single-cell or multiple-cell), bacterial cells (e.g., strains of E. coli, Bacillus spp., Streptomyces spp., etc.), mycobacteria cells, fungal cells, yeast cells (e.g., S. cerevisiae, S. pombe, P. pastoris, P. methanolica, etc.), plant cells, insect cells (e.g., SF-9, SF-21, bacculovirus-infected insect cells, Trichoplusiani, etc.), non-human animal cells, human cells, or cell fusions such as, for example, hybridomas or quadromas. In some embodiments a cell may be a human, monkey, ape, hamster, rat, or mouse cell. In some embodiments, a cell may be eukaryotic and may be selected from the following cells: CHO (e.g., CHO K1, DXB-11 CHO, Veggie-CHO), COS (e.g., COS-7), retinal cell, Vero, CV1, kidney (e.g., HEK293, 293 EBNA, MSR 293, MDCK, HaK, BHK), HeLa, HepG2, WI38, MRC 5, Colo205, HB 8065, HL-60, (e.g., BHK21), Jurkat, Daudi, A431 (epidermal), CV-1, U937, 3T3, L cell, C127 cell, SP2/0, NS-0, MMT 060562, Sertoli cell, BRL 3A cell, HT1080 cell, myeloma cell, tumor cell, and a cell line derived from an aforementioned cell. In some embodiments, a cell may comprise one or more viral genes, e.g. a retinal cell that expresses a viral gene (e.g., a PER.C6™ cell).

The term “target molecule” may be used herein to refer to target polypeptides (e.g., antibodies, antibody fragments, AAV particles, viral proteins, or other proteins or protein fragments), or to other molecules intended to be produced, isolated, purified, and/or included in drug products (e.g., adeno-associated viruses (AAVs) or other molecules for therapeutic use). While methods according to the present disclosure may refer to target polypeptides, they may be as applicable to other target molecules.

AAVs, for example, may be prepared according to suitable methods (e.g., depth filtration, affinity chromatography, and the like), and mixtures including AAVs may be subjected to methods according to the present disclosure. Before or after following one or more methods of the present disclosure, mixtures including AAVs may be subjected to additional procedures (e.g., to the removal of “empty cassettes” or AAVs that do not contain a target sequence).

In some embodiments, the target molecule is an antibody, a human antibody, a humanized antibody, a chimeric antibody, a monoclonal antibody, a multispecific antibody, a bispecific antibody, an antigen binding antibody fragment, a single chain antibody, a diabody, triabody or tetrabody, a Fab fragment or a F(ab′)2 fragment, an IgD antibody, an IgE antibody, an IgM antibody, an IgG antibody, an IgG1 antibody, an IgG2 antibody, an IgG3 antibody, or an IgG4 antibody. In one embodiment, the antibody is an IgG1 antibody. In one embodiment, the antibody is an IgG2 antibody. In one embodiment, the antibody is an IgG4 antibody. In one embodiment, the antibody is a chimeric IgG2/IgG4 antibody. In one embodiment, the antibody is a chimeric IgG2/IgG1 antibody. In one embodiment, the antibody is a chimeric IgG2/IgG1/IgG4 antibody.

In some embodiments, a target molecule (e.g., an antibody) is selected from a group consisting of an anti-Programmed Cell Death 1 antibody (e.g., an anti-PD1 antibody as described in U.S. Pat. Appln. Pub. No. US2015/0203579A1), an anti-Programmed Cell Death Ligand-1 (e.g., an anti-PD-L1 antibody as described in in U.S. Pat. Appln. Pub. No. US2015/0203580A1), an anti-D114 antibody, an anti-Angiopoetin-2 antibody (e.g., an anti-ANG2 antibody as described in U.S. Pat. No. 9,402,898), an anti-Angiopoetin-Like 3 antibody (e.g., an anti-AngPtl3 antibody as described in U.S. Pat. No. 9,018,356), an anti-platelet derived growth factor receptor antibody (e.g., an anti-PDGFR antibody as described in U.S. Pat. No. 9,265,827), an anti-Prolactin Receptor antibody (e.g., anti-PRLR antibody as described in U.S. Pat. No. 9,302,015), an anti-Complement 5 antibody (e.g., an anti-C5 antibody as described in U.S. Pat. Appln. Pub. No US2015/0313194A 1), an anti-TNF antibody, an anti-epidermal growth factor receptor antibody (e.g., an anti-EGFR antibody as described in U.S. Pat. No. 9,132,192 or an anti-EGFRvIII antibody as described in U.S. Pat. Appln. Pub. No. US2015/0259423A1), an anti-Proprotein Convertase Subtilisin Kexin-9 antibody (e.g., an anti-PCSK9 antibody as described in U.S. Pat. No. 8,062,640 or U.S. Pat. Appln. Pub. No. US2014/0044730A1), an anti-Growth And Differentiation Factor-8 antibody (e.g., an anti-GDF8 antibody, also known as anti-myostatin antibody, as described in U.S. Pat. Nos. 8,871,209 or 9,260,515), an anti-Glucagon Receptor (e.g., anti-GCGR antibody as described in U.S. Pat. Appln. Pub. Nos. US2015/0337045A1 or US2016/0075778A1), an anti-VEGF antibody, an anti-ILIR antibody, an interleukin 4 receptor antibody (e.g., an anti-IL4R antibody as described in U.S. Pat. Appln. Pub. No. US2014/0271681A 1 or U.S. Pat. Nos. 8,735,095 or 8,945,559), an anti-interleukin 6 receptor antibody (e.g., an anti-IL6R antibody as described in U.S. Pat. Nos. 7,582,298, 8,043,617 or 9,173,880), an anti-interleukin 33 (e.g., anti-IL33 antibody as described in U.S. Pat. Appln. Pub. Nos. US2014/0271658A 1 or US2014/0271642A1), an anti-Respiratory syncytial virus antibody (e.g., anti-RSV antibody as described in U.S. Pat. Appln. Pub. No. US2014/0271653A1), an anti-Cluster of differentiation 3 (e.g., an anti-CD3 antibody, as described in U.S. Pat. Appln. Pub. Nos. US2014/0088295A1 and US20150266966A1, and in U.S. Application No. 62/222,605), an anti-Cluster of differentiation 20 (e.g., an anti-CD20 antibody as described in U.S. Pat. Appln. Pub. Nos. US2014/0088295A1 and US20150266966A1, and in U.S. Pat. No. 7,879,984), an anti-Cluster of Differentiation-48 (e.g., anti-CD48 antibody as described in U.S. Pat. No. 9,228,014), an anti-Fel dl antibody (e.g., as described in U.S. Pat. No. 9,079,948), an anti-Middle East Respiratory Syndrome virus (e.g., an anti-MERS antibody), an anti-Ebola virus antibody (e.g., Regeneron's REGN-EB3), an anti-CD19 antibody, an anti-CD28 antibody, an anti-IL1 antibody, an anti-IL2 antibody, an anti-IL3 antibody, an anti-IL4 antibody, an anti-IL5 antibody, an anti-IL6 antibody, an anti-IL7 antibody, an anti-Erb3 antibody, an anti-Zika virus antibody, an anti-Lymphocyte Activation Gene 3 (e.g., anti-LAG3 antibody or anti-CD223 antibody) and an anti-Activin A antibody. Each U.S. patent and U.S. patent publication mentioned in this paragraph is incorporated by reference in its entirety.

In some embodiments, a target molecule (e.g., a bispecific antibody) is selected from the group consisting of an anti-CD3 x anti-CD20 bispecific antibody, an anti-CD3 x anti-Mucin 16 bispecific antibody, and an anti-CD3 x anti-Prostate-specific membrane antigen bispecific antibody. In some embodiments, the target molecule is selected from the group consisting of alirocumab, sarilumab, fasinumab, nesvacumab, dupilumab, trevogrumab, evinacumab, and rinucumab.

In some embodiments, the target molecule is a recombinant protein that contains an Fc moiety and another domain, (e.g., an Fc-fusion protein). In some embodiments, an Fc-fusion protein is a receptor Fc-fusion protein, which contains one or more extracellular domain(s) of a receptor coupled to an Fc moiety. In some embodiments, the Fc moiety comprises a hinge region followed by a CH2 and CH3 domain of an IgG. In some embodiments, the receptor Fc-fusion protein contains two or more distinct receptor chains that bind to either a single ligand or multiple ligands. For example, an Fc-fusion protein is a TRAP protein, such as for example an IL-1 trap (e.g., rilonacept, which contains the IL-1RAcP ligand binding region fused to the Il-iR1 extracellular region fused to Fc of hIgG1; see U.S. Pat. No. 6,927,004, which is incorporated by reference in its entirety), or a VEGF trap (e.g., aflibercept or ziv-aflibercept, which contains the Ig domain 2 of the VEGF receptor Fit1 fused to the Ig domain 3 of the VEGF receptor Flk1 fused to Fc of hIgG1; see U.S. Pat. Nos. 7,087,411 and 7,279,159, both of which are incorporated by reference in their entireties). In other embodiments, an Fc-fusion protein is a ScFv-Fc-fusion protein, which contains one or more of one or more antigen-binding domain(s), such as a variable heavy chain fragment and a variable light chain fragment, of an antibody coupled to an Fc moiety.

Charge heterogeneity among biopharmaceutical products can impact the safety and efficacy of a resulting drug product, and may be monitored by biopharmaceutical products manufacturers and regulatory agencies. For example, some charge variants of an intended biopharmaceutical product may exhibit different pharmacokinetics, biological activity, and/or stability, compared to the intended biopharmaceutical product. For example, in the case of antibodies, some isotypes (e.g., charge variants) may degrade or undergo other changes to form a less effective molecule. Improper storage conditions, long storage times, oxidation, or other environmental stresses can affect the efficacy of biopharmaceutical products, and can affect the relative populations of charge variants within a sample.

Charge heterogeneity of biopharmaceutical products may be monitored to ensure consistency between lots across manufacturing processes. Some methods of characterizing charge variants and developing charge-variant profiles are limited to understanding intact proteins or multi-protein structures. However, charge variants can be formed within polypeptides or protein sub-units, and characterization of the larger structures may lack the detail necessary to characterize the charge variants of individual polypeptides or sub-units. For example, charge variant profiles of the light and/or heavy chains of an antibody may provide more information than a charge variant profile of the intact antibody. As another example, a charge variant profile of individual viral proteins may provide more information than a charge variant profile of the intact AAV (e.g., an intact capsid protein).

Capillary isoelectric focusing (CIEF) has been used to characterize charge heterogeneity, and separate charge variants based on their isoelectric point (pI). Depending on the application, CIEF may also be referred to as imaged capillary isoelectric focusing (iCIEF). As described in further detail below, an antibody charge variant profile generated by iCIEF comprises a spectrum of peaks arranged by pI, including a predominant main peak, and peaks for acidic and basic species on both sides of the main peak.

Two-dimensional polyacrylamide gel electrophoresis (2D-PAGE) can separate polypeptides (e.g., protein sub-units) based on isoelectric point in one-dimension, and separate polypeptides based on size in a second dimension. This two-dimensional separation has been used to understand the separate charge heterogeneity associated with antibody heavy and light chains. However, 2D-PAGE can only provide a qualitative assessment of charge isoforms and cannot be used to quantify the proportion of individual charge isoforms relative to each other. Additionally, 2D-PAGE is time and labor intensive, and can result in streaking, which lowers the overall resolution of the analysis and detection of low abundance isoforms.

To address the limitations of 2D-PAGE, a method using size-exclusion chromatography (SEC) and iCIEF was developed. The method, referred to as ChromiCE, can be used to detect and quantitate the charge variants corresponding to the heavy and light chains of the antibody separately. ChromiCE includes reducing and denaturing an antibody, and loading the reduced and denatured antibody on a size exclusion column to separate the components of the heavy and light chains. The separated heavy and light chains can be individually loaded onto an isoelectric focusing platform, and iCIEF can be used to identify and quantitate the charge isoforms associated with the heavy and light chains.

Unlike 2D-PAGE, ChromiCE provides quantitative results. However, data collection and analysis from ChromiCE can last as long as a week, due to the time intensive separation of light and heavy chains. Further, the mobile phase used in the SEC step of ChromiCE utilizes a buffer with a high urea concentration (e.g., approximately 8M urea) which can alter the sample, as well as negatively impact column life and the longevity of the involved instrumentation.

Embodiments of the present disclosure may include methods for identifying and quantifying charge variants of biopharmaceutical products, such as, for example, methods that address the aforementioned shortcomings of 2D-PAGE and ChromiCE methods. Embodiments of the present disclosure may be used to identify and quantify charge variants of native polypeptides such as, for example, native antibodies and/or native AAV particles. In addition or alternatively, embodiments of the present disclosure may be used to identify and quantify charge variants of reduced and denatured polypeptides. Reduced and denatured polypeptides that may be analyzed with methods of the present disclosure include antibodies (e.g., heavy chains, light chains, F(ab′)2 fragments, Fc fragments, or other polypeptides) and/or reduced and denatured AAV particles (e.g., VP proteins or other polypeptides). Methods of the present disclosure for identifying and quantifying charge variants of biopharmaceutical products may be referred to as iCIEF-Western methods.

Methods of the present disclosure may include separating charge variants based on their isoelectric points using capillary isoelectric focusing. Methods of the present disclosure (e.g., iCIEF-Western methods) do not include a chromatography separation (e.g., an SEC step). According to embodiments of the present disclosure, after polypeptides are separated based on their isoelectric points, an iCIEF-Western method utilizes peptide-specific antibodies to quantify and characterize specific portions of proteins and the charge variants of the portions.

In some embodiments, an analyte may need to be prepared, prior to processing the analyte via methods of the present disclosure (e.g., iCIEF-Western methods). As used herein, “analyte” may refer to a sample, solution, mixture, drug product, or other composition that includes a target polypeptide (e.g., an antibody, an AAV particle, or other polypeptide). Preparing the analyte may include preparing a loading buffer that includes the analyte.

The loading buffer may include one or more components that aid in the separation of charge variants and/or the identification of charge variants. For example, a loading buffer may include one or more carrier ampholytes, one or more celluloses (e.g., hydroxyl propyl methyl cellulose), a pI ladder, a base (e.g., urea), formamide, glycerol, ethylene, propylene glycerol, water, or a combination thereof. In some embodiments, a loading buffer may include a lysis buffer (e.g., Bicine/CHAPS lysis buffer). The carrier ampholytes may assist in creating an electrical gradient during the separation of charge variants. The carrier ampholytes may include those sold under the tradename Pharmalytes, such as, for example, Pharmalytes (3-10) and Pharmalytes (5-8). The pI ladder may provide a standardized marking on the results of the CIEF step, using molecules with known pI values. The pI ladder and carrier ampholytes may be selected based on the theoretical pIs of the analyte. The inclusion of a base, such as, for example, urea, may prevent species within the loading buffer from converting to other charge variants. The inclusion of a base (e.g., urea) within the loading buffer may assist in maintaining the denatured state of fragments of polypeptides (e.g., denatured antibody fragments or denature viral proteins) within the analyte.

One exemplary sample preparation includes the preparation of a loading buffer master mix, and subsequent preparation of the sample comprising the loading buffer and the analyte. Preparation of the loading buffer master mix may include dissolving hydroxyl propyl methyl cellulose in a urea solution (e.g., a lysis buffer including at least 6M urea) to generate a 1 weight percent (wt. %) hydroxyl propyl methyl cellulose solution that has a urea concentration of at least 6M. For example, the 1 wt. % hydroxyl propyl methyl cellulose solution may include a urea concentration of approximately 8M. The loading buffer master mix may be generated according to the proportions shown in Table 1.

TABLE 1

| | Volume Percentage |
|---|---|
| Reagent | (vol. %) |
| 1 wt. % hydroxyl propyl methyl | approximately 78% |
| cellulose solution | |
| carrier ampholytes | approximately 18% |
| pI ladder | approximately 4% |

After the loading buffer master mix is prepared, a sample for an iCIEF-Western analysis may be prepared. The sample may include the analyte, water, a lysis buffer, the loading buffer master mix, or a combination thereof. The sample may have a urea concentration of greater than or equal to approximately 8M. The sample may have a cellulose (e.g., hydroxyl propyl methyl cellulose) concentration of approximately 1 wt. %. In an exemplary embodiment, samples may be prepared according to the proportions shown in Table 2.

TABLE 2

| Reagent | Volume Percentage (vol. %) |
|---|---|
| loading buffer master mix | approximately 74% |
| lysis buffer including 12M urea | approximately 24% |
| analyte | approximately 2% |

Another exemplary sample preparation is shown below in Table 3. The sample preparation in Table 3 may be used, for example, with analytes including adeno-associated viruses.

TABLE 3

| | Volume Percentage |
|---|---|
| Reagent | (vol. %) |
| 1 wt. % hydroxyl propyl methyl | approximately 43% |
| cellulose solution | |
| formamide | approximately 30% |
| dimethyl sulfoxide | approximately 8% |
| tris(2-carboxyethyl) phosphine (TCEP) | approximately 6% |
| carrier ampholytes | approximately 2.5% |
| pI ladder | approximately 2% |
| analyte | approximately 6% |

As described herein, an analyte may be reduced and denatured prior to being analyzed. Reduced and denatured analytes may be buffer exchanged prior to the preparation of the sample buffer. A buffer exchanged analyte may include a solution comprising urea (e.g., approximately 8M urea), sodium phosphate (e.g., approximately 10 mM sodium phosphate), tris(2-carboxyethyl) phosphine (TCEP) (e.g., approximately 1 mM TCEP), and/or the analyte. Another exemplary sample preparation is shown below in Table 4, for use with some buffer exchanged analytes. The sample preparation in Table 4 may be used, for example, with reduced and denatured analytes including antibodies.

TABLE 4

| | Volume Percentage |
|---|---|
| Reagent | (vol. %) |
| 1 wt. % hydroxyl propyl methyl | approximately 46% |
| cellulose solution | |
| 12M urea solution | approximately 44% |
| carrier ampholytes | approximately 2.7% |
| pI ladder | approximately 2.2% |
| analyte | approximately 2-5% |

The sample preparation and loading buffers may be adjusted to allow for sufficient separation and stability of polypeptide. For example, depending on the properties of the analyte (e.g., polypeptide concentration, viscosity, or other physiochemical property) the loading buffer and sample preparation compositions may be adjusted. In addition or alternatively, parameters of the CIEF separation may be adjusted to accommodate the physiochemical properties of the sample. For example, if an analyte has a greater than average concentration of peptides, the resulting sample may have a greater than average viscosity. Loading time and focusing associated with the CIEF separation may be adjusted to account the increased sample viscosity. As other examples, ampholyte selection, ampholyte concentration, sample solution viscosity, sample analyte concentration may need to be adjusted to allow for sufficient separation and stability of polypeptide charge variants.

Methods of the present disclosure may be used to separate and quantify charge variants of reduced and denatured polypeptides. An analyte may be incubated in a solution that reduces and denatures the constituent polypeptides of the analyte, prior to the iCIEF-Western analysis. In some embodiments, the analyte may be incubated in such a solution for approximately one hour. For example, an analyte may be incubated in a solution comprising 6M guanidine HCl and 10 mM tris(2-carboxyethyl)phosphine (TCEP) to reduce and denature the polypeptides of the analyte. In the example of analyte including antibodies, the antibodies may be reduced and denatured resulting in a solution with denatured light and heavy chains. Other types of denaturants and/or other types protein digestion may be employed to further characterize charge variants of target analytes. In some embodiments, proteases such as IdeS, papain, or pepsin, may be used to digest target polypeptides into fragments.

The reduced and denatured analyte may then be buffer exchanged with a buffer including approximately 35 mM to approximately 50 mM sodium phosphate, approximately 1 mM to approximately 10 mM TCEP, and approximately 6 M to approximately 8 M urea, at a pH of approximately 6.0. Then the buffer exchanged analyte may be combined with a loading buffer and a lysis buffer comprising approximately 10 M to approximately 12 M urea. For example the buffer exchanged analyte may be combined with loading buffer master mix and lysis buffer according to the proportions shown in Table 2. In addition or alternatively, the buffer exchanged analyte may be combined with other sample buffer components according to the proportions shown in Table 3 or Table 4.

After the sample is prepared, the sample may be loaded into a capillary. Samples may be run in parallel, such as, for example, in parallel capillaries. In some embodiments, samples are loaded into a well plate and an automated fluid handling system transports the samples and other reagents into capillaries. As an electrical current is applied to the sample, species within the sample (e.g., ampholytes, pI ladder, charge variants within the sample) may be separated along the capillary according to their isoelectric point (pI). For example, 21000 pWatts of electrical power may be applied for 30 minutes. The run time of an isoelectric focusing separation may adjusted based on the composition (e.g., conductivity, viscosity, or other property) of the sample. In addition or alternatively, different sample compositions may require different focus times in order to achieve optimal resolution of charge variants.

As electrical energy is applied to the capillary, species with the sample may form a gradient according to the isoelectric points such that the species with the lowest isoelectric point are located at a first end of the capillary and species with the highest isoelectric point are located at the second end of the capillary. The iCIEF separation may be accomplished using an isoelectric focusing platform, such as, for example, a PeggySue™ instrument manufactured by ProteinSimple.

After the charge variants within the sample are separated based on the isoelectric points, specific antibodies may be used to detect polypeptides and quantify their relative abundances. In some embodiments, separated charge variants may be immobilized onto the capillary wall. The matrix including the capillary may be washed to remove excess reagents. Prior to the introduction of detection antibodies, the matrix including the capillaries may be blocked. For example, the matrix may be incubated in a bovine serum albumin solution or milk for at least approximately 30 minutes.

After blocking, the matrix may be washed and detection antibodies may be added. As previously described, after polypeptides are reduced and denatured, charge variants of fragments of the polypeptides can be separately quantified with specific detection antibodies. In the example of an iCIEF-Western analysis of antibodies, specific anti-human Fc antibodies may be used to detect and quantify heavy chain charge variants, and anti-human Kappa antibodies may be used to detect and quantify light chain charge variants. In an iCIEF-Western analysis of AAV particles, specific anti-VP proteins may be used to detect and quantify viral protein variants. Incubation in the specific detection antibodies may be referred to as the primary incubation. The matrix may be incubated in antibodies that are specific to one or more polypeptides for at least approximately 60 minutes. In some examples, such as anti-human Fc protein antibodies and anti-human kappa protein antibodies used in detection of heavy and light chains of antibodies, a suitable detection antibody concentration may be approximately 1 μg/mL to approximately 10 μg/mL. In some embodiments, a suitable detection antibody concentration may be approximately 2 μg/mL to 400 μg/mL.

Other types of specific detection may be employed to further characterize charge variants of polypeptides. For example, instead of incubating the matrix in a detection antibody, the matrix may be incubated in an antigen that has specific binding capability to a target polypeptide.

After the primary incubation, the matrix may be washed and a secondary incubation may take place. The secondary incubation step may last at least approximately 120 minutes. The secondary incubation may bind one or more reporter molecules to the detection antibodies. The reporter molecules may be capable of generating a detectable signal (e.g., a chemiluminescent signal) that can be used to quantify charge variants. The strength of the detectable signal may correlate to a concentration or abundance of the reporter molecule. Due to the specificity of the detection antibodies, the concentration or abundance of the reporter molecule (e.g., and strength of the resulting signal) correlates to a concentration or abundance of the target charge variants.

After the secondary incubation, the matrix may be washed and one or more reporting agents may be introduced into the capillary. The reporting agent may interact with the reporter molecule to generate a detectable signal that corresponds to each charge variant. Because the species within the sample were already separated based on their isoelectric point, the location of each signal from the interaction of the reporting agent with the report molecule is indicative of which charge variant the signal corresponds to. The strength of the detectable signal may correspond to the relative abundance of the corresponding charge variant at that location. The strength of the detectable signal may be plotted against the isoelectric point at the position of the signal to generate an electropherogram.

The peak areas of the electropherogram may be calculated with a Gaussian distribution algorithm. The area of an individual peak, divided by the total area under all peaks of the electropherogram, may correspond to the relative abundance of the charge variant that corresponds to the individual peak. Electropherograms may be analyzed with the aid of a processor and/or software, such as, for example, Compass software (e.g., version 4.0.0). A charge variant profile may refer to the electropherogram, or the relative abundances of charge variants quantified from the electropherogram and/or the isoelectric point of the charge variants. Further examples of electropherograms and quantification of charge variants via the calculation of peak areas are described below.

In one or more embodiments, an exemplary detection scheme uses horseradish peroxidase (HRP) conjugated to streptavidin as a reporter molecule. For example, after the primary incubation in detection antibodies, the matrix may be washed and incubated in a mixture including HRP conjugated to streptavidin. The streptavidin may preferentially bind to the biotin of the detection antibodies, and the HRP may cause a chemiluminescent reaction when luminol-peroxide is introduced. After the secondary incubation, and a subsequent washing, luminol-peroxide may be injected into the capillaries, thereby generating chemiluminescent signals from the interaction of the luminol-peroxide with the HRP.

Because the isotypes of each sample are separated on a pI gradient prior to detection, measured chemiluminescence (e.g., at 425 nm for detection antibodies with an HRP conjugate) of a peak is correlated to the relative abundance of the isotype represented by the peak. The electropherogram generated based on the measured chemiluminescence signals can be used to identify the charge variants of each analyzed polypeptide, and quantify relative abundances of those charge variants.

When developing an iCIEF-Western protocol, several conditions may have to be adjusted based on the nature of the sample. For example, the concentration of detection antibodies may need to be adjusted to improve the signal-to-noise ratio. In determining a suitable detection antibody concentration, application specific factors such as target polypeptide concentration, range of charge variants, binding affinity of detection antibodies are considered.

Although some iCIEF-Western methods have been described above in the context of antibodies and portions of antibodies, they may be used to characterize charge variant profiles of any proteinaceous biopharmaceutical products. In one embodiment, iCIEF-Western assays may be used to characterize charge variant profiles of one or more proteins produced by an adeno-associated virus (AAV).

As known to those of ordinary skill in the art, adeno-associated viruses (AAVs) may be used to deliver corrective genes into cells or tissues of a target organism. For example, a therapeutic gene may be inserted into the AAV genome, and with the assistance of a helper virus, the AAV may deliver the therapeutic gene to one or more target cells. AAVs are non-pathogenic and non-toxic. Different AAV serotypes may be used depending on the application. Each AAV serotype may have a different cell-transduction efficiency for different types of cells, making some AAV serotypes more suitable for target certain organ systems, organs, and/or tissues. For example, AAVrh10 and AAV2 have the highest cell-transduction efficiency for brain tissue; AAV2 and AAV4 have the highest cell-transduction efficiency for eye tissue; AAV6 and AAV1 have the highest cell-transduction efficiency for lung tissue; AAV1 and AAV8 have the highest cell-transduction efficiency for muscle tissue; AAV8, AAV5, and AAV9 have the have the highest cell-transduction efficiency for liver tissue; and AAV9 and AAVrh10 have the highest systemic cell-transduction efficiency.

There are three main AAV capsid proteins, often referred to as VP1, VP2, and VP3. The sequences of the AAV capsid proteins may vary between AAV serotypes. Therefore, detection antibodies that are suitable for use in analyzing charge variants of polypeptides produced by one AAV serotype may not be suitable for other serotypes. In some embodiments, methods of the present disclosure include developing detection antibodies that are specific to AAV capsid proteins. For example, methods of the present disclosure may include developing rabbit polyclonal antibodies that bind to capsid proteins of a specific AAV serotype.

In some instances, the VP2 sequence includes the VP3 sequences, and the VP1 sequence includes the VP2 sequence. Stated differently, a detection antibody that is specific to VP3 may also bind to VP1 and VP2, and a detection antibody that is specific to VP2 may also bind to VP1. For example, one or more recombinant peptides from the portion of the VP1 sequence not shared by VP2 and VP3 may be used as a rabbit antigen to generate a VP1-specific polyclonal antibody; one or more recombinant peptides from the portion of the VP2 sequence not shared by VP3 may be used as a rabbit antigen to generate a polyclonal antibody with specificity to VP2 and VP1; and one or more recombinant peptides from VP3 may be used as a rabbit antigen to generate a polyclonal antibody with specificity to VP3, VP2, and VP1. Methods that use such detection antibodies can still quantify charge variants of AAV capsid proteins by comparing the relative electropherogram generated by each detection antibody. Additional examples of iCIEF-Western analyses of AAV capsid proteins are described below (e.g., Examples 12-25).

As described herein, methods of the present disclosure (e.g., iCIEF-Western methods) may be used to generate a charge variant profile of a target polypeptide within a sample. The generated charge variant profiles may be used to validate iCIEF-Western methods, validate manufacturing conditions of a lot, and assess the impact of manufacturing or storage conditions on the stability of a biopharmaceutical product.

For example, charge variants may be quantified for two different lots of the same biopharmaceutical product. Quantifying relative populations of charge variants and verifying that they match known or theoretical charge variant profiles, can be used to validate a method for quantification developed via iCIEF-Western.

Additionally, the charge variant profiles of different lots may be compared to determine, confirm, or validate the process conditions under which the lots were manufactured. If the charge profile of an antibody from a first lot under validated manufacturing and environmental conditions is known, it can be compared to the charge variant profile of a newly manufactured lot to confirm that the lot was not subject to excess thermal or environmental stress. Further, if changes to manufacturing conditions or equipment are made, comparing the charge variant profile of lots manufactured under the new conditions, with the charge variant profile of lots manufactured under validated conditions can assess the efficacy of the changes to the manufacturing conditions and/or equipment.

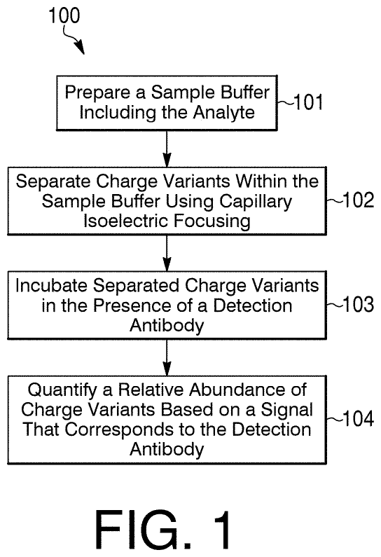

Referring to FIG. 1, a flow chart for an exemplary method 100 for separating and quantifying charge variants of native polypeptides within an analyte is shown. The method 100 may include preparing a sample buffer including the analyte (step 101). The sample buffer may include one or more carrier ampholytes, one or more celluloses (e.g., hydroxyl propyl methyl cellulose), a pI ladder, a base (e.g., urea), water, or a combination thereof. In some embodiments, the sample buffer is prepared according to the proportions shown in Tables 1 and 2. In addition or alternatively, the sample buffer may be prepared according to the proportions shown in Table 3 or Table 4. Method 100 may include separating charge variants within the sample buffer using capillary isoelectric focusing (step 102). For example, the sample buffer may be loaded into a capillary and separated using an isoelectric focusing platform.

After the charge variants of the native polypeptides (e.g., antibodies, AAV particles, or other polypeptides) are separated, method 100 may include incubating the separated charge variants in the presence of a detection antibody (step 103). The detection antibody may be specific to one or more target polypeptides or target amino acid sequences within the analyte. After the detection antibody conjugates to the charge variants of a target polypeptide, a relative abundance of each charge variant may be quantified based on a signal that corresponds to the detection antibody (step 104).

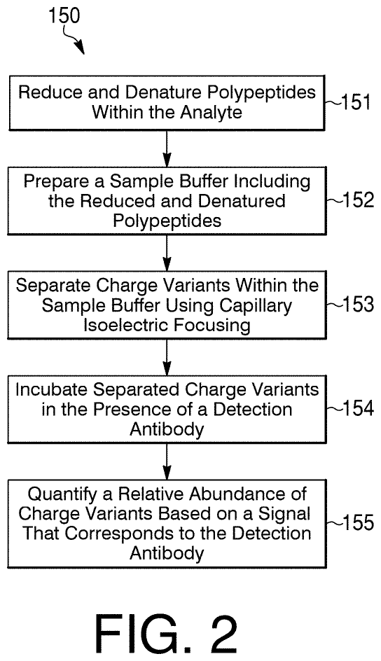

Referring to FIG. 2, a flow chart for an exemplary method 150 for separating and quantifying charge variants of reduced and denatured polypeptides within an analyte is shown. The method 150 may include reducing and denaturing polypeptides within the analyte (step 151). For example, the analyte may be incubated in a solution comprising 6M guanidine HCl and 10 mM tris(2-carboxyethyl)phosphine (TCEP) to reduce and denature the polypeptides of the analyte. Method 150 may include preparing a sample buffer including the analyte (step 152). The reduced and denatured samples may be buffer exchanged into a buffer including 8M Urea, 35 mM Sodium Phosphate, and 1 mM TCEP. A sample buffer may then be prepared with the buffer exchanged samples, according to the proportions shown in Tables 1 and 2. In addition or alternatively, the sample buffer may be prepared according to the proportions shown in Table 3 or Table 4.

Method 150 may include separating charge variants within the sample buffer using capillary isoelectric focusing (step 153). For example, the sample buffer may be loaded into a capillary and separated using an isoelectric focusing platform. After the charge variants of the reduced and denatured polypeptides (e.g., antibody heavy chains, antibody light chains, viral proteins, or other polypeptides) are separated, method 150 may include incubating the separated charge variants in the presence of a detection antibody (step 154). The detection antibody may be specific to one or more target polypeptides or target amino acid sequences within the analyte. After the detection antibody conjugates to the charge variants of a target polypeptide, a relative abundance of each charge variant may be quantified based on a signal that corresponds to the detection antibody (step 155).

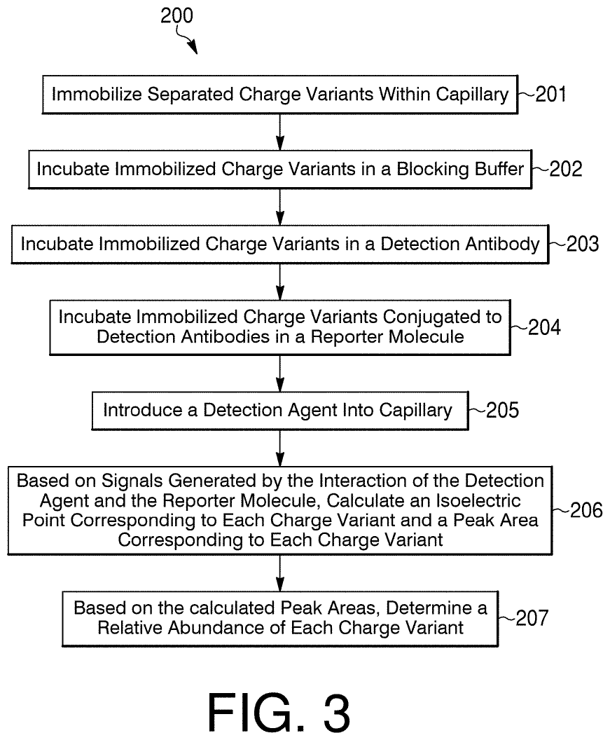

As described herein, methods (e.g., methods 100, 150) of separating and quantifying charge variants of polypeptides may include quantifying a relative abundance of charge variants based on a signal that corresponds to a detection antibody. Referring to FIG. 3, a flow chart of an exemplary method 200 of quantifying relative abundances of charge variants based on a signal that corresponds to the detection antibody is shown.

The method 200 may include immobilizing separated charge variants within the capillary (step 201). For example, after charge variants are separated along an isoelectric gradient within the capillary, the charge variants may be irreversibility immobilized to a wall of the capillary. Method may include incubating the immobilized charge variants in a blocking buffer (step 202). In some embodiments, the capillary (e.g., a matrix including the capillary) may be washed prior incubating the immobilized charge variants in the blocking buffer.

Method 200 may further include incubating the immobilized charge variants in a detection antibody (step 203). Incubating the immobilized charge variants in the detection antibody may be referred to as the primary incubation. In some embodiments, the capillary (e.g., a matrix including the capillary) may be washed after removal of the blocking buffer and prior to the primary incubation. As described herein, one or more detection antibodies may be used that are specific to one or more polypeptides (e.g., target polypepties). For example, biotinylated goat anti-human IgG Fc specific polyclonal antibody (pAb) may be used to detect antibody heavy chains and biotinylated goat anti-human kappa pAb may be used to detect antibody light chains. In other examples, antibodies that bind specifically to certain viral proteins or protein sub-units may be used as detection antibodies. During the primary incubation, the detection antibodies may conjugate to the target polypeptides.

Method 200 may include incubating the immobilized charge variants conjugated to detection antibodies in a reporter molecule (step 204). The incubation in the reporter molecule may be referred to as a secondary incubation. In some embodiments, the capillary (e.g., a matrix including the capillary) may be washed between the primary incubation and the secondary incubation. The reporter molecule may preferentially bind to the detection antibodies. Additionally, the reporter molecule may have a functional group or sub-unit that is capable of generating a signal (e.g., a bioluminescent or chemiluminescent signal). In some embodiments, the functional group or sub-unit that is capable of generating a signal may generate the signal in response to an external stimulus (e.g., a chemical or physical stimulus).

Method 200 may further include introducing a detection agent into the capillary (step 205). In some examples, the reporter molecule only generates the signal in the presence of a detection agent. In the example of a reporter molecule including HRP conjugated to streptavidin, the signal is only generated when the HRP is exposed to a luminol-peroxide. Method 200 may further include calculating an isoelectric point corresponding to each charge variant and a peak area corresponding to each charge variant, based on signals generated by the interaction of the detection agent and the reporter molecule (step 206).

In some embodiments, method 200 may further include determining a relative abundance of each charge variant, based on the calculated peak areas (step 207). For example, the peak area corresponding to each charge variant may be divided by the sum of all peak areas to determine a relative abundance of each charge variant.

### EXAMPLES

In the examples described herein, unless noted otherwise, monoclonal antibodies may comprise IgG1 and IgG4, and/or are derived from CHO cells.

In examples where polypeptides are reduced and denatured, unless noted otherwise, the polypeptides were reduced and denatured in the presence 6M GuHCl and 10 mM TCEP for an hour at room temperature. The reduced and denatured samples were then buffer exchanged into a buffer including 8M Urea, 35 mM Sodium Phosphate, and 1 mM TCEP.

For each example described herein, unless noted otherwise, iCIEF-Western analytes were included in sample buffers prepared with lysis buffer, carrier ampholytes, a pI ladder, and hydroxyl propyl methylcellulose, according to the proportions shown in Tables 1 and 2. For the examples that include reduced and denatured polypeptides, the buffer exchanged samples were included in sample buffers prepared with lysis buffer, carrier ampholytes, a pI ladder, and hydroxyl propyl methylcellulose, according to the proportions shown in Tables 1 and 2. The sample buffers, detection antibodies, reporter molecules, and a luminol-peroxide mix were loaded into a 384-well plate and then automatically injected into the capillaries of the iCIEF instrument. In the examples described herein, iCIEF separations and analysis were carried out using a PeggySue™ instrument manufactured by ProteinSimple. The samples were electrophoresed by applying 21000 pWatts for 30 minutes.

### Example 1

As previously described, a charge variant profile of an analyte may be generated using an iCIEF-Western method. The charge variant profile for the analyte (e.g., a manufacturing lot of biopharmaceutical products) may be compared to a known charge variant profile of the analyte, to validate the iCIEF-Western method.

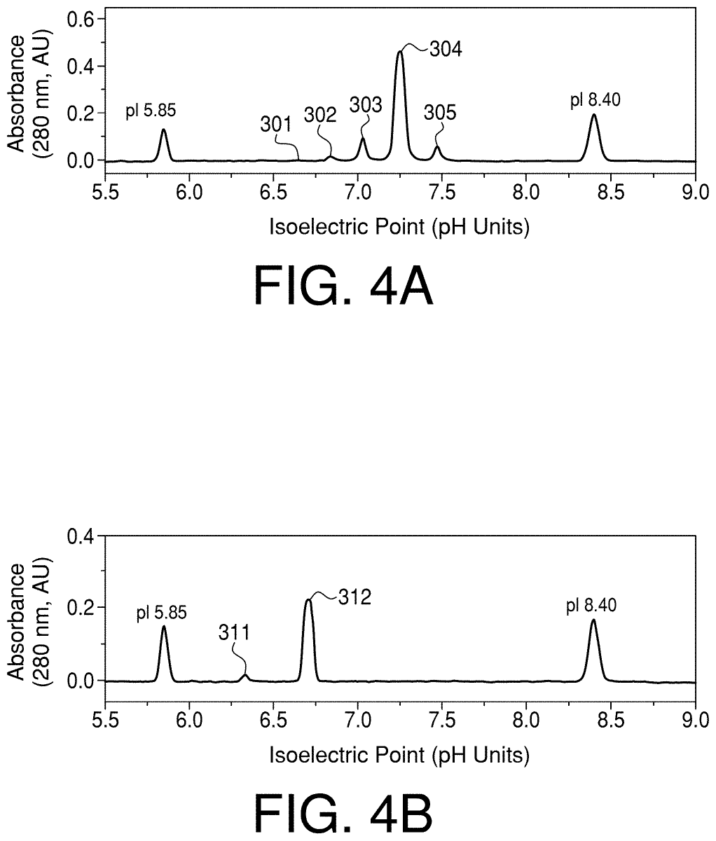

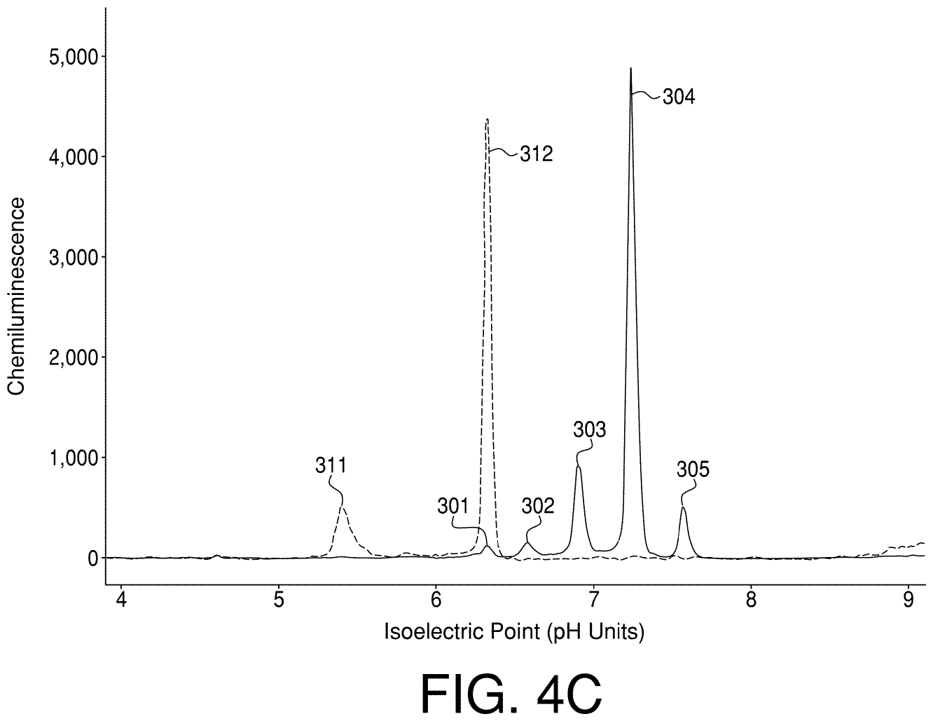

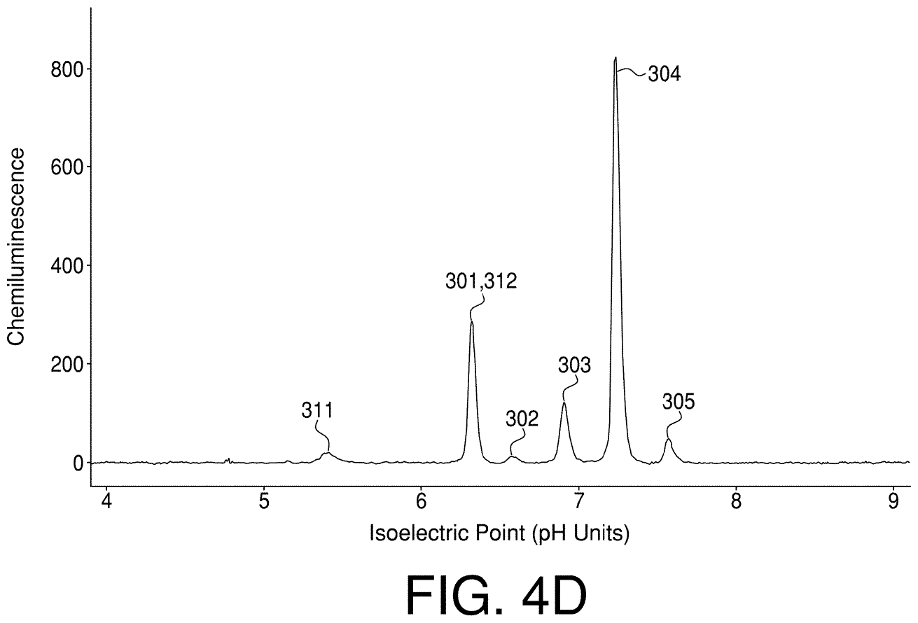

A charge variant profile was generated for reduced and denatured antibodies from a single manufacturing lot of Antibody 1 using ChromiCE, and is shown in FIGS. 4A and 4B. As previously described, ChromiCE requires a chromatography step to separate heavy and light chain antibodies. The electropherogram of the heavy chain antibodies is shown in FIG. 4A and the electropherogram of the light chain antibodies is shown in FIG. 4B. The electropherograms generated using ChromiCE also show peaks at isoelectric points of 5.85 and 8.40, that correspond to isoelectric point markers included in the sample buffer.

A charge variant profile was generated for reduced and denatured antibodies from the same manufacturing lot of Antibody 1 using an iCIEF-Western method, and is shown in FIG. 4C. Biotinylated goat anti-human IgG Fc specific polyclonal antibody (pAb) was used as the detection antibody for the heavy chains of the reduced and denatured antibodies. Biotinylated goat anti-human kappa pAb was used as the detection antibody for the light chains of the reduced and denatured antibodies. Streptavidin conjugated to HRP was used as a reporter molecule, and luminol-peroxide was used as a reporting agent. In FIG. 4C, the signals detected from the Fc pAb (e.g., signals corresponding to heavy chain charge variants) are shown as a solid line, and the signals detected from the kappa pAb (e.g., signals corresponding to light chain charge variants) are shown as a dashed line.

The electropherogram generated using iCIEF-Western (FIG. 4C) includes the same peaks (e.g., peaks 301, 302, 303, 304, 305, 311, and 312) at the same locations as the electropherograms generated using ChromiCE (FIGS. 4A and 4B).

Referring to FIG. 4D, a charge variant profile was generated for reduced and denatured antibodies from the same manufacturing lot of Antibody 1, using iCIEF-Western. Anti-human H+L antibodies were used as detection antibodies without specificity for a specific portion the analyte antibody. As can be seen in FIG. 4D, a peak for a heavy chain charge variant (peak 301) overlaps with a peak for a light chain charge variant (peak 312). Using multiple detection antibodies in an iCIEF-Western method can improve the detectability of peaks. Additionally, the use of multiple detection antibodies may improve resolution of adjacent peaks.

### Example 2

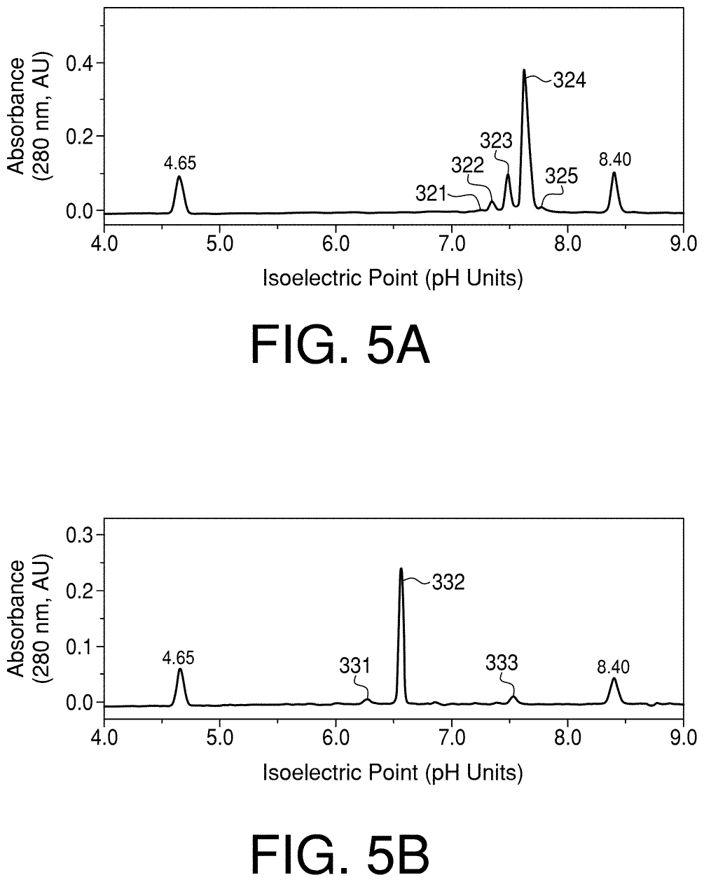

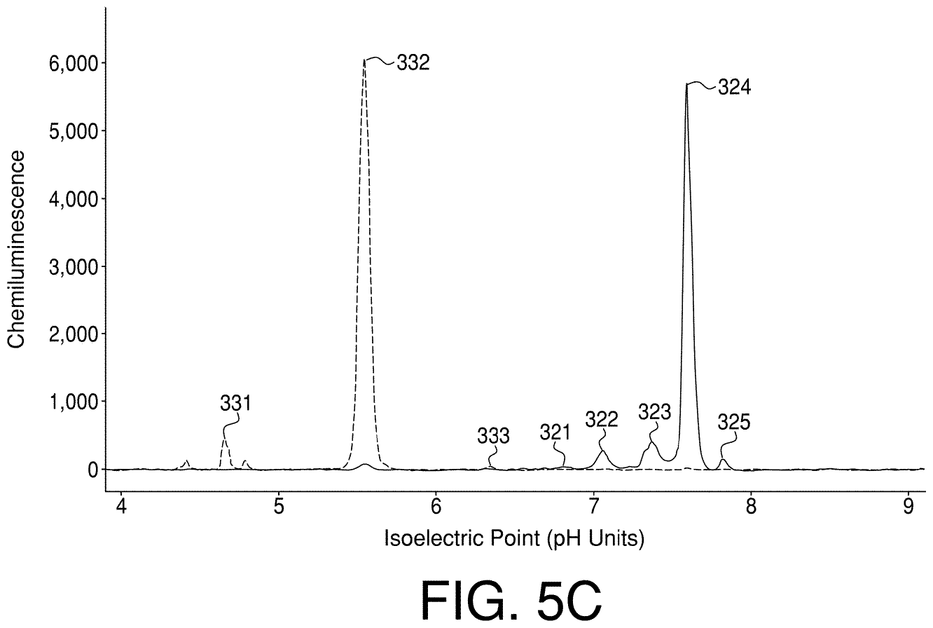

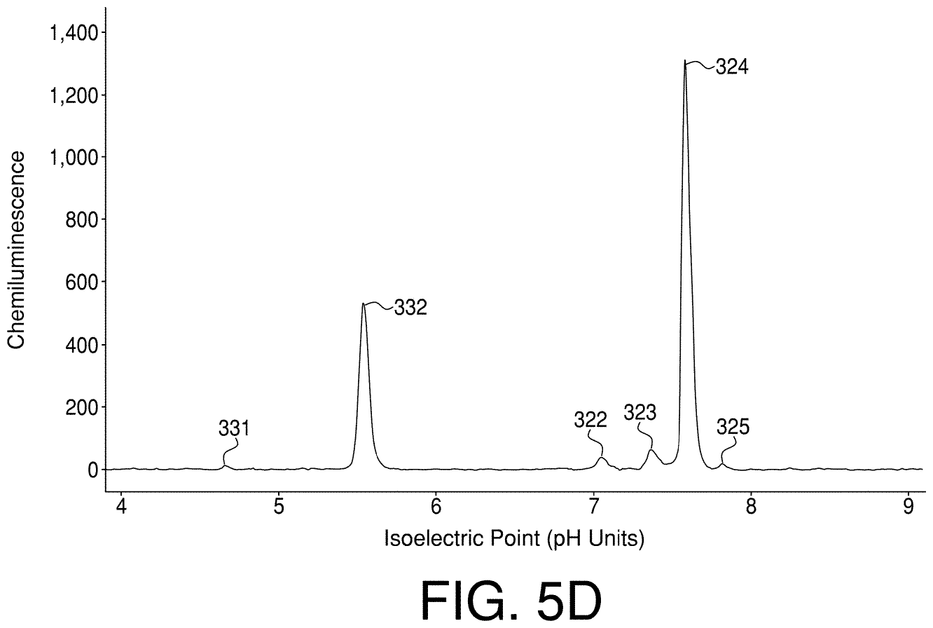

A charge variant profile was generated for reduced and denatured antibodies from a single manufacturing lot of Antibody 2 using ChromiCE, and is shown in FIGS. 5A and 5B. The electropherogram of the heavy chain antibodies is shown in FIG. 5A and the electropherogram of the light chain antibodies is shown in FIG. 5B. The electropherograms generated using ChromiCE also show peaks at isoelectric points of 4.65 and 8.40, that correspond to isoelectric point markers included in the sample buffer.

A charge variant profile was generated for reduced and denatured antibodies from the same manufacturing lot of Antibody 2 using an iCIEF-Western method, and is shown in FIG. 5C. Biotinylated goat anti-human IgG Fc specific pAb was used as the detection antibody for the heavy chains of the reduced and denatured antibodies. Biotinylated goat anti-human kappa pAb was used as the detection antibody for the light chains of the reduced and denatured antibodies. Streptavidin conjugated to HRP was used as a reporter molecule, and luminol-peroxide was used as a reporting agent. In FIG. 5C, the signals detected from the Fc pAb (e.g., signals corresponding to heavy chain charge variants) are shown as a solid line, and the signals detected from the kappa pAb (e.g., signals corresponding to light chain charge variants) are shown as a dashed line.

The electropherogram generated using iCIEF-Western (FIG. 5C) includes the same peaks (e.g., peaks 321, 322, 323, 324, 325, 331, 332, and 333) at the same locations as the electropherograms generated using ChromiCE (FIGS. 5A and 5B).

Referring to FIG. 5D, a charge variant profile was generated for reduced and denatured antibodies from the same manufacturing lot of Antibody 2, using iCIEF-Western. Anti-human H+L antibodies were used as detection antibodies without specificity for a specific portion the analyte antibody. As can be seen in FIG. 5D, some known peaks of the analyte (e.g., peaks 333 and 321) were not detected. Using multiple detection antibodies in an iCIEF-Western method can improve the detectability of peaks. Additionally, the use of multiple detection antibodies may improve resolution of adjacent peaks.

### Example 3

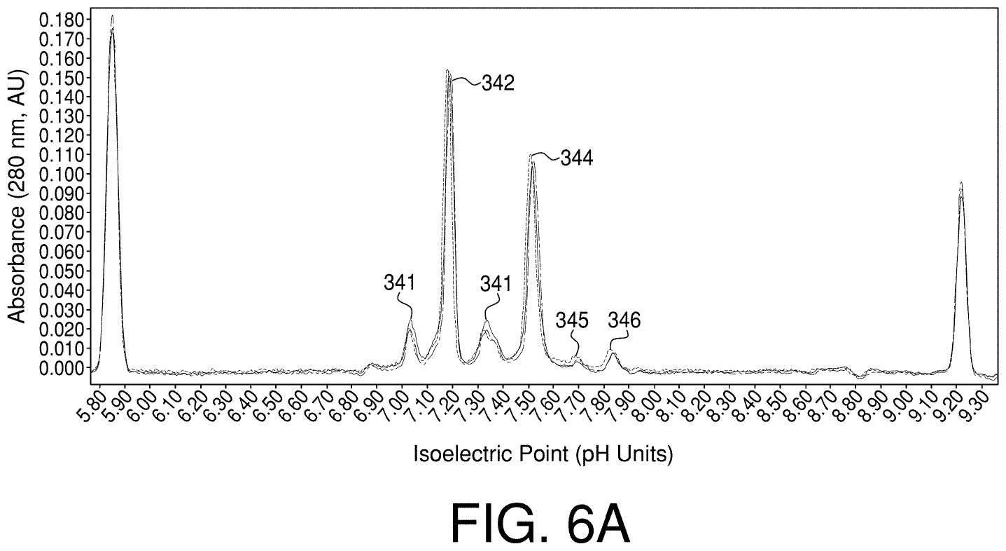

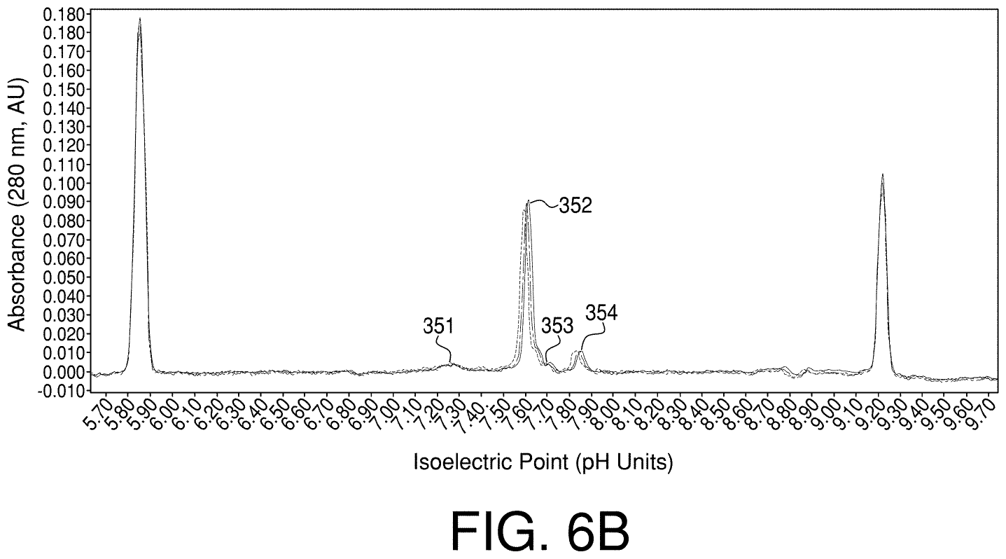

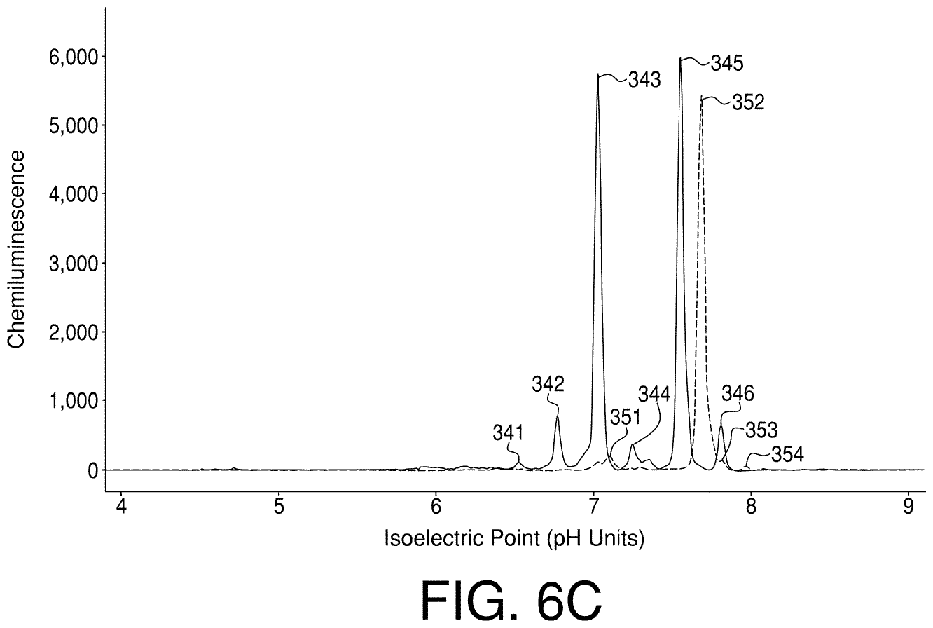

A charge variant profile was generated for reduced and denatured antibodies from a single manufacturing lot of Antibody 3 using ChromiCE, and is shown in FIGS. 6A and 6B. The ChromiCE analysis was run in triplicate, and the electropherograms of each run are imposed upon each other. The electropherograms of the heavy chain antibodies are shown in FIG. 6A and the electropherograms of the light chain antibodies are shown in FIG. 6B. The electropherograms generated using ChromiCE also show peaks at isoelectric points of approximately 5.85 and approximately 9.25, that correspond to isoelectric point markers included in the sample buffer.

A charge variant profile was generated for reduced and denatured antibodies from the same manufacturing lot of Antibody 3 using an iCIEF-Western method, and is shown in FIG. 6C. Biotinylated goat anti-human IgG Fc specific pAb was used as the detection antibody for the heavy chains of the reduced and denatured antibodies. Biotinylated goat anti-human kappa pAb was used as the detection antibody for the light chains of the reduced and denatured antibodies. Streptavidin conjugated to HRP was used as a reporter molecule, and luminol-peroxide was used as a reporting agent. In FIG. 6C, the signals detected from the Fc pAb (e.g., signals corresponding to heavy chain charge variants) are shown as a solid line, and the signals detected from the kappa pAb (e.g., signals corresponding to light chain charge variants) are shown as a dashed line.

The electropherogram generated using iCIEF-Western (FIG. 6C) includes the same peaks (e.g., peaks 341, 342, 343, 344, 345, 346, 351, 352, 353, and 354) at the same locations as the electropherograms generated using ChromiCE (FIGS. 6A and 6B).

### Example 4

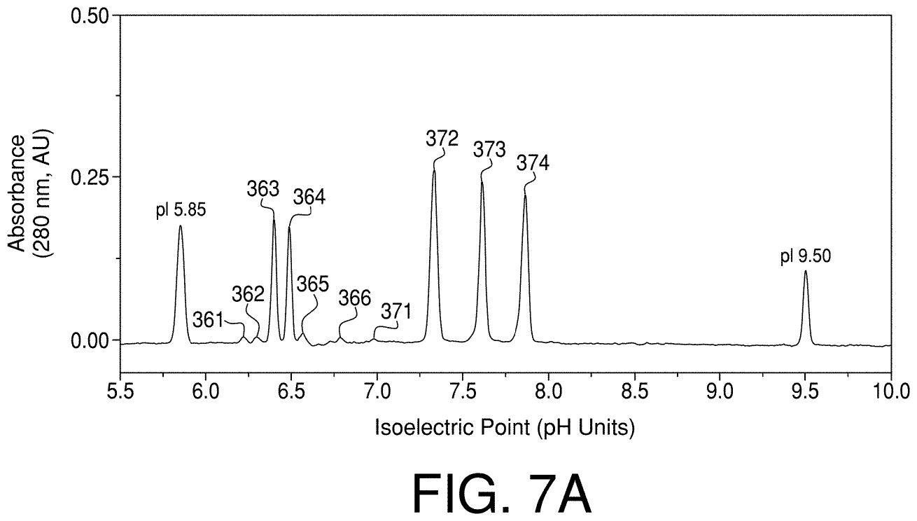

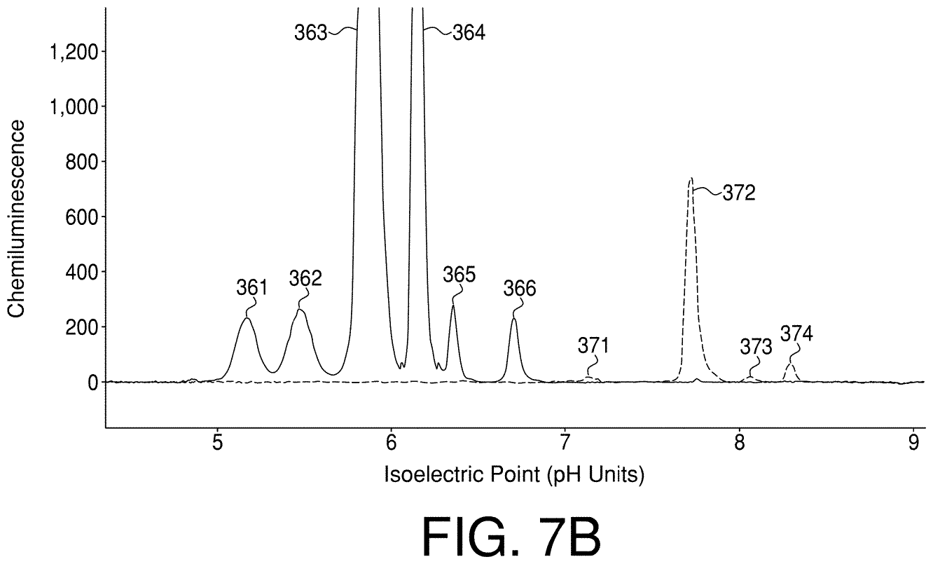

In contrast to the above mentioned reduction and denaturing method, polypeptides (e.g., antibodies) within an analyte may be digested by a protease (e.g., IdeS). IdeS cleaves antibodies into F(ab′)2 and Fc fragments. Analytes including Antibody 3, from the same manufacturing lot used in Example 3, were digested using IdeS. A charge variant profile of the F(ab′)2 and Fc fragments was generated using ChromiCE, and is shown in FIGS. 7A. Peaks 361, 362, 363, 364, 365, and 366 correspond to charge variants of Fc fragments. Peaks 371, 372, 373, and 374 correspond to charge variants of F(ab′)2 fragments. Because Fc fragments generally have a lower isoelectric point than F(ab′)2 fragments, the peaks corresponding to Fc fragments do not overlap with the peaks corresponding to F(ab′)2 fragments. The electropherogram generated using ChromiCE also show peaks at isoelectric points of 5.85 and 9.50, that correspond to isoelectric point markers included in the sample buffer.

A charge variant profile of the F(ab′)2 and Fc fragments was also generated using an iCIEF-Western method, and is shown in FIG. 7B. Anti-human H+L antibodies were used as detection antibodies without specificity for a specific portion the analyte antibody. In FIG. 7B, the signals detected from the Fc fragments are shown as a solid line, and the signals detected from F(ab′)2 fragments are shown as a dashed line. The electropherogram generated using iCIEF-Western (FIG. 7B) includes the same peaks (e.g., peaks 361, 362, 363, 364, 365, 366, 371, 372, 373, and 374) at the same locations as the electropherograms generated using ChromiCE (FIG. 7A).

### Example 5

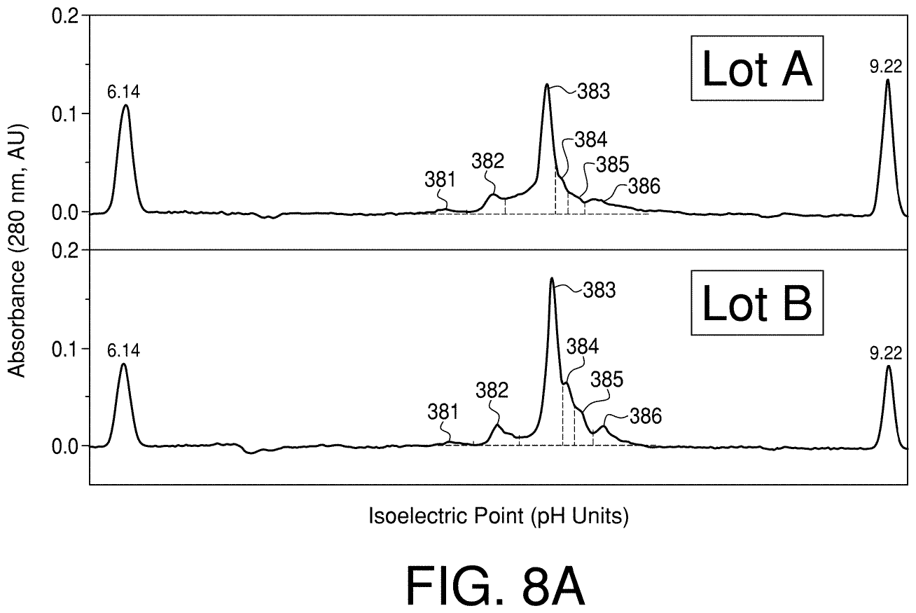

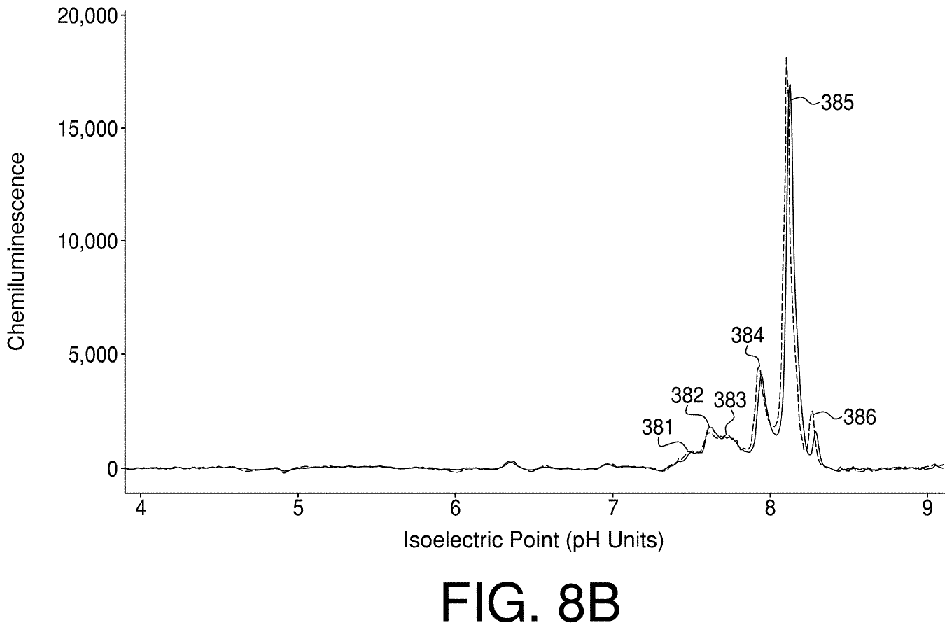

A charge variant profile was generated for reduced and denatured antibodies from two manufacturing lots (Lots A and B) of Antibody 4 using ChromiCE, and is shown in FIG. 8A. Only the electropherogram of the heavy chain antibodies is shown. The electropherogram generated using ChromiCE also show peaks at isoelectric points of 6.14 and 9.22, that correspond to isoelectric point markers included in the sample buffer.

A charge variant profile was generated for reduced and denatured antibodies from manufacting lots A and B using an iCIEF-Western method, and is shown in FIG. 8B. Biotinylated goat anti-human IgG Fc specific pAb was used as the detection antibody for the heavy chains of the reduced and denatured antibodies. Streptavidin conjugated to HRP was used as a reporter molecule, and luminol-peroxide was used as a reporting agent. In FIG. 8B, the electropherogram corresponding to Lot A is shown as a dashed line, and the electropherogram corresponding to Lot B is shown as a solid line.

The electropherogram generated using iCIEF-Western (FIG. 8B) includes the same peaks (e.g., peaks 381, 382, 383, 384, 385, and 386) at the same locations as the electropherograms generated using ChromiCE (FIG. 8A). Further, the electropherogram generated using iCIEF-Western has better resolution than the electropherogram generating using ChromiCE. In addition, using iCIEF-Western, the charge variants of the heavy chain were characterized without the use of a chromatography step. Without being limited by theory, the poorer heavy chain resolution associated with ChromiCE may be attributed to degradation of the analyte from the high concentration of urea in the size-exclusion chromatography (SEC) buffers and the long process times of the SEC step.

### Example 6

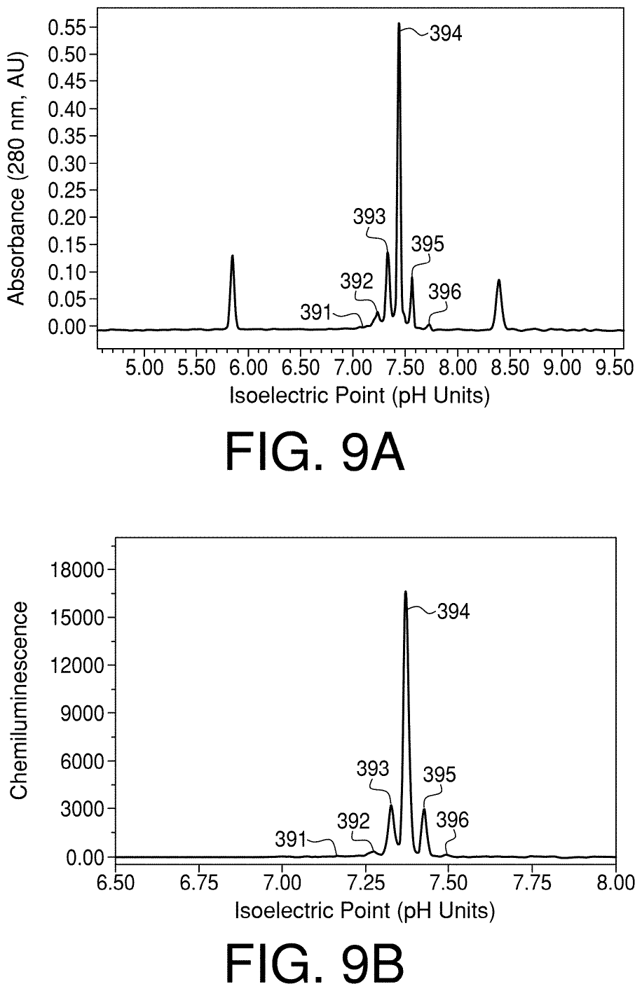

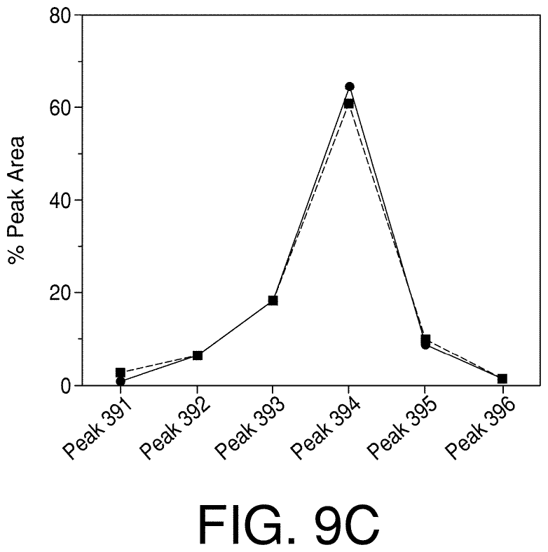

A charge variant profile was generated for the heavy chain of reduced and denatured antibodies from a single manufacturing lot of Antibody 5 using ChromiCE, and is shown in FIG. 9A. The electropherogram generated using ChromiCE also show peaks at isoelectric points of approximately 5.85 and approximately 8.4, that correspond to isoelectric point markers included in the sample buffer.

A charge variant profile was generated for the heavy chain of reduced and denatured antibodies from the same manufacturing lot of Antibody 5, using iCIEF-Western, and is shown in FIG. 9B. Biotinylated goat anti-human IgG Fc specific pAb was used as the detection antibody for the heavy chains of the reduced and denatured antibodies. Streptavidin conjugated to HRP was used as a reporter molecule, and luminol-peroxide was used as a reporting agent.

The electropherogram generated using iCIEF-Western (FIG. 9B) includes the same peaks (e.g., peaks 391, 392, 393, 394, and 395) at the same locations as the electropherogram generated using ChromiCE (FIG. 9A). Peak 393 corresponds to the predominant species of the heavy chain of Antibody 5; peaks 391 and 392 correspond to acidic variants of the heavy chain of Antibody 5; and peaks 394 and 395 correspond to basic variants of the heavy chain of Antibody 5.

The peak areas for each peak were also calculated for the electropherogram generated using ChromiCE (FIG. 9A) and the electropherogram generated using iCIEF-Western (FIG. 9B). The peak areas were plotted as percentage of the total area under all peaks, and are shown in FIG. 9C. The peak areas calculated based on the ChromiCE electropherogram are represented by the squares and dashed line, the peak areas calculated based on the iCIEF-Western electropherogram are represented by the circles and solid line. As shown in FIG. 9C, the peak areas calculated based on the ChromiCE electropherogram (FIG. 9A) are similar to the peak areas calculated based on the iCIEF-Western electropherogram (FIG. 9B).

### Example 7

A charge variant profile generated via iCIEF-Western for a first lot of antibodies may be compared to a known charge variant profile, or the charge variant profile for a second lot of antibodies. Comparison of the charge variant profile of the first lot of antibodies may validate the process conditions under which the first lot of antibodies was produced.

The charge variant profile of reduced and denatured antibodies from a first lot (Lot A) of Antibody 6 was compared to the charge variant profile of reduced and denatured antibodies from a second lot (Lot B) of Antibody 6. Biotinylated goat anti-human IgG Fc specific pAb was used as the detection antibody for the heavy chains of the reduced and denatured antibodies. Biotinylated goat anti-human kappa pAb was used as the detection antibody for the light chains of the reduced and denatured antibodies. Streptavidin conjugated to HRP was used as a reporter molecule, and luminol-peroxide was used as a reporting agent.

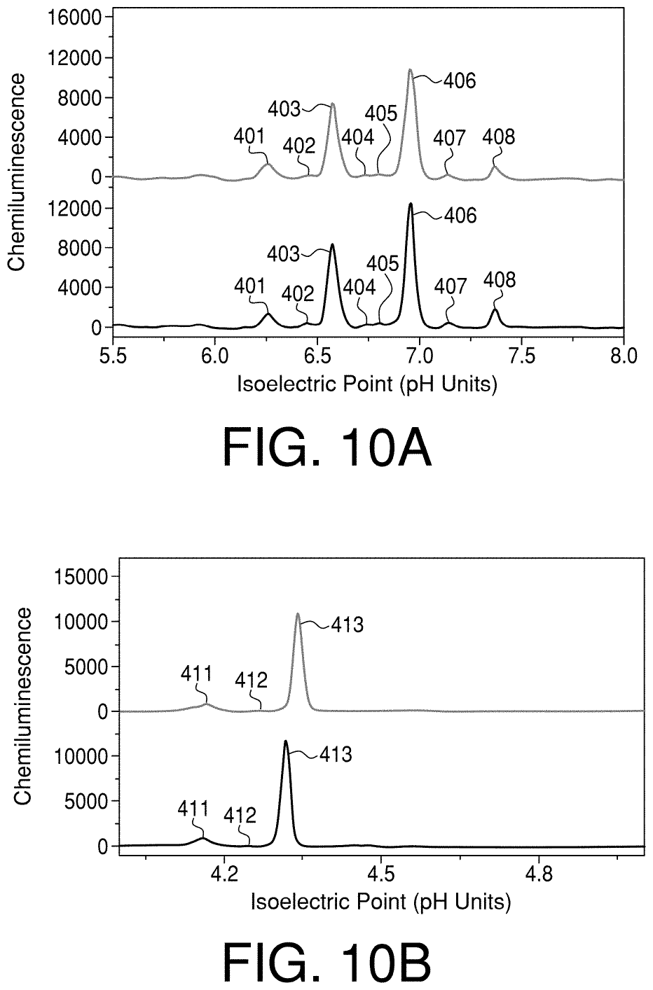

The electropherograms generated based on the Fc pAb, including heavy chain charge variants, are shown in FIG. 10A, and the electropherograms generated based on the kappa pAb, including the light chain charge variants, are shown in FIG. 10B. The charge variant profile of Lot A is shown as a grey line and the charge variant profile of Lot B is shown as a black line. Still referring to FIGS. 10A and 10B, the charge variant profile of Lot A is the same as the charge variant profile of Lot B. For example, the electropherogram for Lot A includes the same peaks as the electropherogram for Lot B (e.g., peaks 401, 402, 403, 404, 405, 406, 407, 408, 411, 412, and 413). Additionally, the peak areas for Lot A may be compared to Lot B, to ensure the proportions of each charge variant are the same between Lots A and B.

### Example 8

The charge variant profile of reduced and denatured antibodies from a first lot (Lot A) of Antibody 7 was compared to the charge variant profile of reduced and denatured antibodies from a second lot (Lot B) of Antibody 7. Biotinylated goat anti-human IgG Fc specific pAb was used as the detection antibody for the heavy chains of the reduced and denatured antibodies. Biotinylated goat anti-human kappa pAb was used as the detection antibody for the light chains of the reduced and denatured antibodies. Streptavidin conjugated to HRP was used as a reporter molecule, and luminol-peroxide was used as a reporting agent.

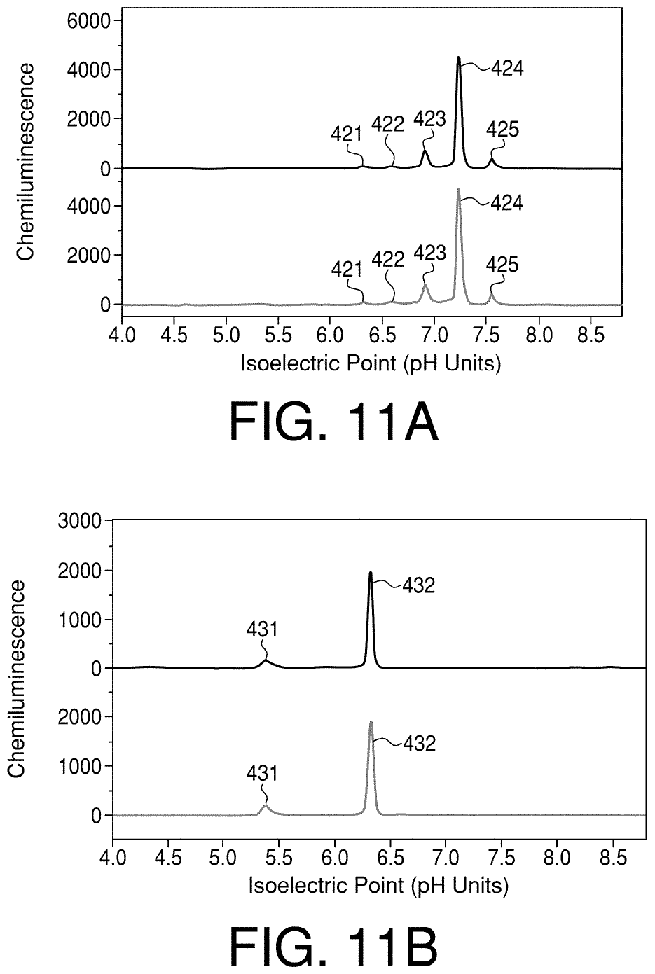

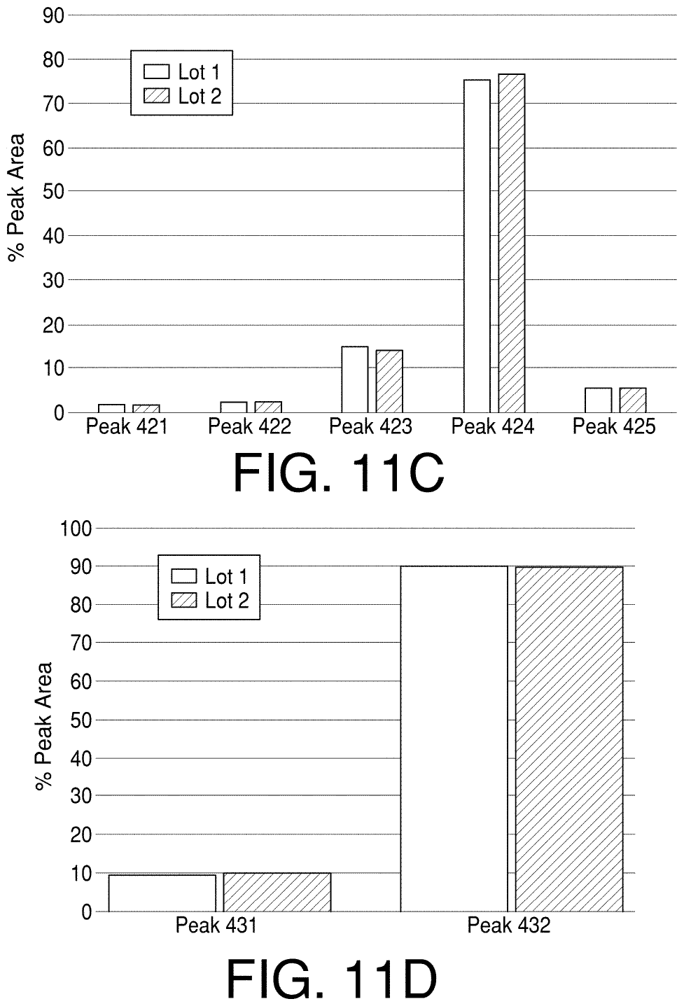

The electropherograms generated based on the Fc pAb, including heavy chain charge variants, are shown in FIG. 11A, and the electropherograms generated based on the kappa pAb, including the light chain charge variants, are shown in FIG. 11B. The charge variant profile of Lot A is shown as a grey line and the charge variant profile of Lot B is shown as a black line. Still referring to FIGS. 10A and 10B, the charge variant profile of Lot A is the same as the charge variant profile of Lot B. For example, the electropherogram for Lot A includes the same peaks as the electropherogram for Lot B (e.g., peaks 421, 422, 423, 424, 425, 431, and 432).

Additionally, the peak areas for Lot A may be compared to Lot B, to ensure the proportions of each charge variant are the same between Lots A and B. The relative peak areas for the heavy chain charge variants of Lots A and B are shown in FIG. 11C. The relative peak areas for the light chain charge variants of Lots A and B are shown in FIG. 11D.

### Example 9

The charge variant profile of native antibodies from a first lot (Lot A) of Antibody 8 was compared to the charge variant profile of native antibodies from a second lot (Lot B) of Antibody 8. Lot A was subjected to thermal stress. Specifically, Lot A was stored at 40° C. for three months. Biotinylated goat anti-human IgG Fc specific pAb was used as the detection antibody for the heavy chains of the reduced and denatured antibodies. Biotinylated goat anti-human kappa pAb was used as the detection antibody for the light chains of the reduced and denatured antibodies. Streptavidin conjugated to HRP was used as a reporter molecule, and luminol-peroxide was used as a reporting agent.

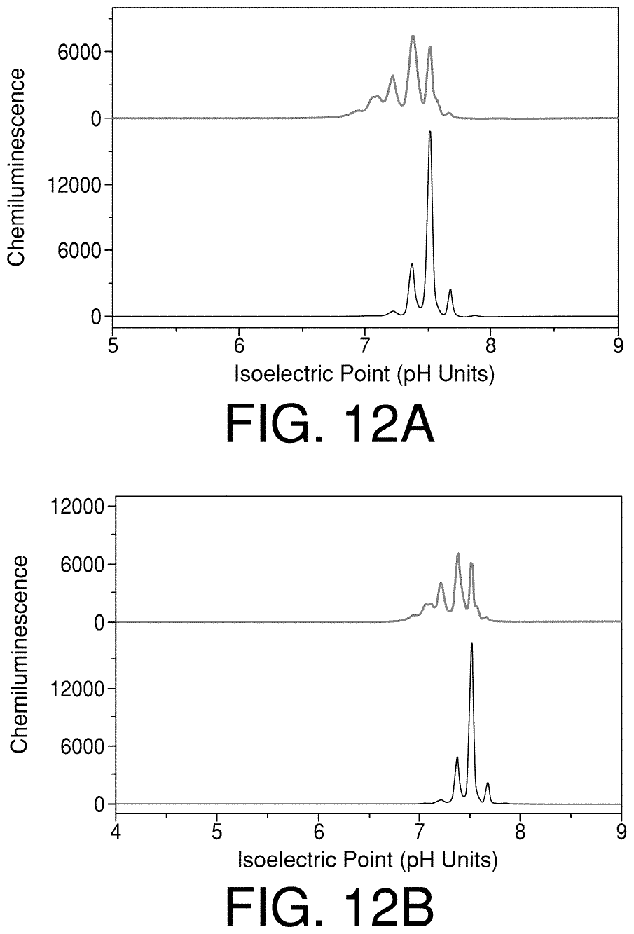

The electropherograms based on the Fc pAb (heavy chain detection) are shown in FIG. 12A and the electropherograms based on kappa pAB detection are shown in FIG. 12B. For both FIGS. 12A and 12B, the electropherograms of Lot A (the thermally stressed lot) are represented by a grey line and the electropherograms of Lot B (the not thermally stressed lot) are represented by a black line. From the charge variant profiles of the native antibodies, it is apparent that relative proportions of charge variants are different between the thermally stressed and not thermally stressed lots. However, there is no baseline separation of the peaks, and the individual isotypes cannot be reliably quantified.

The charge variant profile of reduced and denatured antibodies from a Lot A of Antibody 8 were compared to the charge variant profile of reduced and denatured antibodies from Lot B of Antibody 8. Biotinylated goat anti-human IgG Fc specific pAb was used as the detection antibody for the heavy chains of the reduced and denatured antibodies. Biotinylated goat anti-human kappa pAb was used as the detection antibody for the light chains of the reduced and denatured antibodies. Streptavidin conjugated to HRP was used as a reporter molecule, and luminol-peroxide was used as a reporting agent.

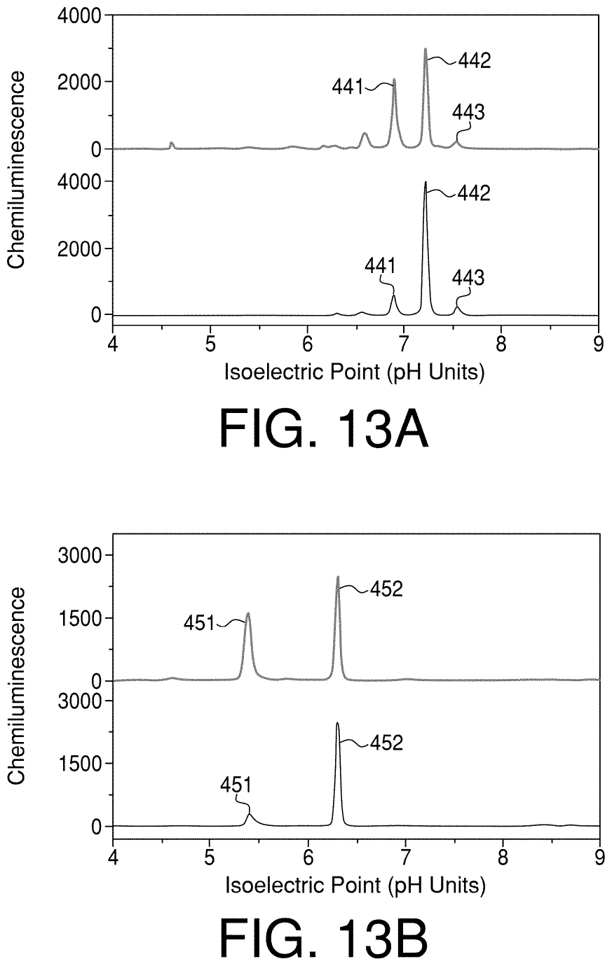

The electropherograms based on the Fc pAb (heavy chain detection) are shown in FIG. 13A and the electropherograms based on kappa pAB (light chain detection) are shown in FIG. 13B. For both FIGS. 13A and 13B, the electropherograms of Lot A (the thermally stressed lot) are represented by a grey line and the electropherograms of Lot B (the not thermally stressed lot) are represented by a black line.

The isoelectric points of the heavy and light chains when dissociated are different than the isoelectric points of the intact antibodies. As a result, iCIEF-Western methods were able to generate a charge variant profile with baseline resolution and quantify individual charge isotypes of the light and heavy chains.

Referring to FIG. 13A, peak 442 corresponds to the main charge variant of the heavy chain of Antibody 8, peak 441 corresponds to an acidic charge variant of the heavy chain, and peak 443 corresponds to a basic charge variant of the heavy chain. Referring to FIG. 13B, peak 452 corresponds to the main charge variant of the light chain of Antibody 8, and peak 451 corresponds to an acidic charge variant of the light chain of Antibody 8. The peak areas were calculated based on the electropherograms for Lot A (thermally stressed) and Lot B (not thermally stressed), and are summarized in Table 5. The area of each peak was integrated and divided by the total area of all peaks to determine a relative peak area corresponding to each peak (e.g., corresponding to each detected charge variant).

TABLE 5

| | | Relative Peak Area ( %) | |
|---|---|---|---|
| Peak Number | | Lot A | Lot B |
| Fc pAb detection | 441 | 50.6 | 18.2 |
| (heavy chain) | 442 | 43.0 | 76.2 |
| | 443 | 4.1 | 5.5 |
| kappa pAb detection | 451 | 38.1 | 10.1 |
| (light chain) | 452 | 61.9 | 88.9 |

The thermally stressed lot, compared to the not thermally stressed lot, has a lower relative abundance of the main isotype and an increased abundance of the acidic isotype, for both light and heavy chains. Charge variant profiles may be generated for unknown lots of antibodies and compared to the charge variant profiles of thermally stressed lots and not thermally stressed lots. The comparison of charge variant profiles can inform whether the unknown lot was subject to thermal stress or other undesirable storage condition.

### Example 10

In developing an iCIEF-Western method for characterizing charge variants of a polypeptide, it can be useful to adjust the concentration of detection antibodies. Each combination of target polypeptide and detection antibody may require a different concentration of detection antibodies during the primary incubation step. iCIEF-Western analyses may be conducted with different concentrations of detection antibodies to determine a suitable concentration of detection antibodies.

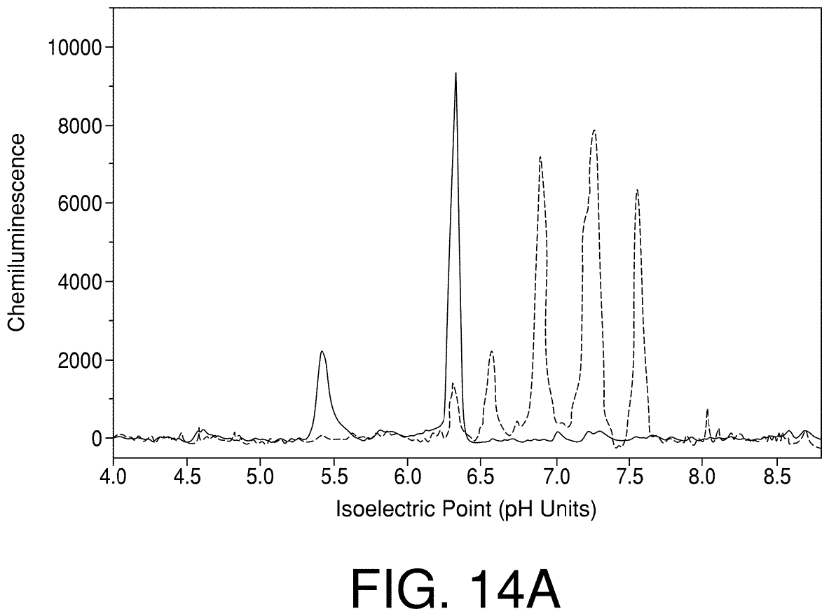

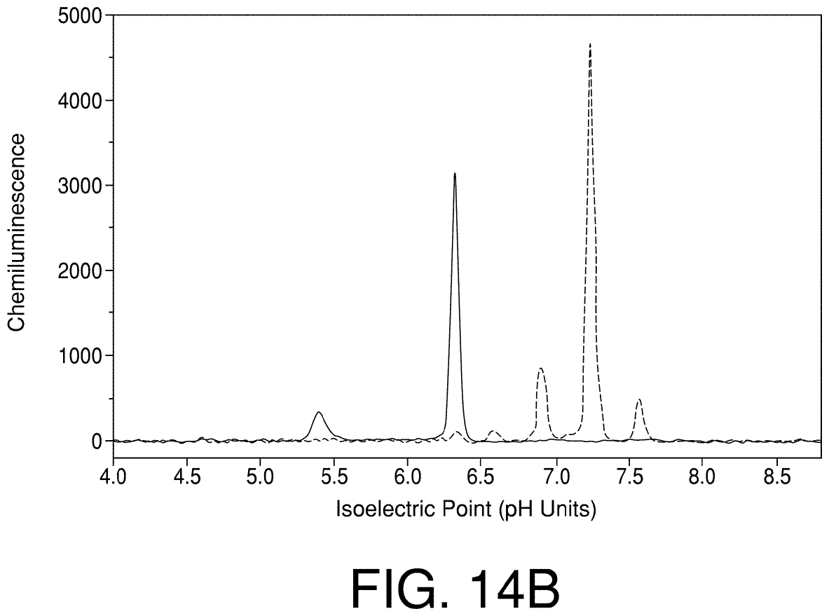

Charge variant profiles were generated for a reduced and denatured analyte including Antibody 9, using iCIEF-Western methods with different concentrations of detection antibodies, and are shown in FIGS. 14A and 14B. The method used to produce the charge variant profile shown in FIG. 14A included a primary incubation in detection antibodies, at an antibodies concentration of approximately 100 μg/mL. The method used to produce the charge variant profile shown in FIG. 14B included a primary incubation in detection antibodies, at an antibodies concentration of approximately 2.5 μg/mL. Biotinylated goat anti-human IgG Fc specific pAb was used as the detection antibody for the heavy chains of the reduced and denatured antibodies. Biotinylated goat anti-human kappa pAb was used as the detection antibody for the light chains of the reduced and denatured antibodies. Streptavidin conjugated to HRP was used as a reporter molecule, and luminol-peroxide was used as a reporting agent. In FIGS. 14A and 14B, the signals detected from the Fc pAb (e.g., signals corresponding to heavy chain charge variants) are shown as a solid line, and the signals detected from the kappa pAb (e.g., signals corresponding to light chain charge variants) are shown as a dashed line.

Referring to FIG. 14A, an iCIEF-Western analysis conducted with an excess concentration of detection antibodies may result in excess baseline noise, detection of erroneous peaks, poor resolution, and/or skewed or asymmetrical peaks. Referring to FIG. 14B, an iCIEF-Western analysis conducted with a suitable concentration of detection antibodies may include a consistent baseline with limited background noise, and separated peaks resolved to the baseline. Adjusting detection antibody concentration can reduce baseline noise, and therefore increase the measured signal-to-noise ratio, facilitating improved detection of low abundance charge variants in the dynamic range.

### Example 11

In order to properly characterize VP proteins with iCIEF-Western, VP protein specific antibodies may be developed. Antibodies were developed with specificity for VP proteins for AAV8 serotype AAVs. A recombinant portion from the portion of the VP1 sequence not shared by VP2 and VP3 was used as a rabbit antigen to generate a VP1-specific polyclonal antibody. Two recombinant peptides from the portion of the VP2 sequence not shared by VP3 were used as a rabbit antigen to generate a polyclonal antibody with specificity to VP2 and VP1. A recombinant peptide from VP3 was used as a rabbit antigen to generate a polyclonal antibody with specificity to VP3, VP2, and VP1. As shorthand, the polyclonal antibody that binds with specificity to VP3, VP2, and VP1 may be referred to as the anti-VP3NP2NP1 antibody, the polyclonal antibody that binds with specificity to VP2 and VP1 may be referred as the anti-VP2NP1 antibody, and the polyclonal antibody that binds with specificity to VP1 may be referred to as the anti-VP1 antibody.

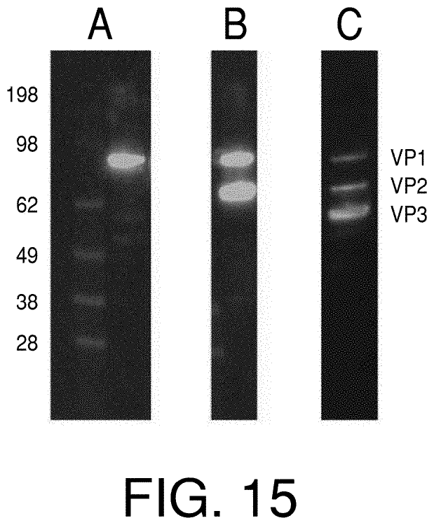

A western blot was used to confirm that the developed anti-VP3NP2NP1 antibody, anti-VP2NP1 antibody, and anti-VP1 antibody polyclonal antibodies binded to their intended targets. The results of the western blot at shown in FIG. 15. The left-most blot (A) used the anti-VP1 antibody as the primary antibody, the middle blot (B) used the anti-VP1NP2 antibody as the primary antibody, and the right-most blot (c) used the anti-VPINP2NP3 antibody as the primary antibody. The molecular weights of the bands in the reference ladder are shown on the left side of FIG. 15, in kiloDaltons (kDa). The bands corresponding to VP1, VP2, and VP3 proteins are marked on the right side of FIG. 15. The anti-VP1 pAb binded to only VP1, the anti-VP1NP2 pAb binded to VP1 and VP2, and the anti-VPlNP2NP3 antibody binded to VP1, VP2, and VP3.

### Example 12

By using all three VP protein specific rabbit antibodies described in Example 11, charge variants of VP1, VP2, and VP3 can be identified and quantitated, using iCIEF-Western. For example, even though the anti-VP3NP2NP1 antibody binds to VP1, VP2, and VP3, the chemiluminescence profile generated by the anti-VP3NP2NP1 antibody can be compared to profiles generated by other antibodies, to determine which peaks correspond to VP1 charge variants, VP2 charge variants, and VP3 charge variants.

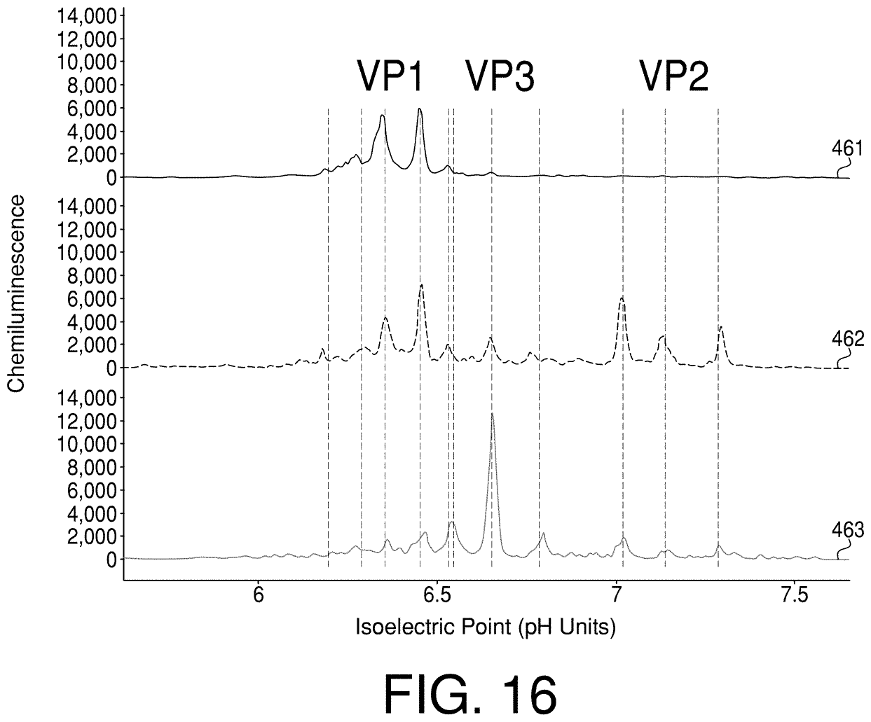

Referring to FIG. 16, a charge variant profile for a reduced and denatured analyte including AAV8 serotype AAVs was generated using an iCIEF-Western method. The rabbit polyclonal antibodies described in Example 11 were used as detection antibodies. An anti-rabbit antibody conjugated to HRP was used as a reporter molecule, and luminol-peroxide was used as a reporting agent. Line 461 represents the electropherogram generated using anti-VP1 as the detection antibody, line 462 represents the electropherogram generated using anti-VP1NP2 as the detection antibody, and line 463 represents the electropherogram generated using anti-VPINP2NP3 as the detection antibody. The profile generated from the anti-VP3NP2NP1 antibody (line 463) can be compared with the profiles generated from the anti-VP3NP2 antibody (line 462) and the anti-VP1 antibody (line 461) to determine which peaks are associated with VP1, which peaks are associated with VP2, and which peaks are associated with VP3. As shown in FIG. 16, there are five charge variant peaks associated with VP1, three charge variant peaks associated with VP3, and three charge variant peaks associated with VP3.

The theoretical pI of each analyte polypeptide can also assist in the association of chemiluminescence peaks with VP protein charge variants. For example, for VP proteins from an AAV8 serotype AAV: the main charge variant of VP1 has an isoelectric point of 6.01, the main charge variant of VP2 has an isoelectric point of 6.87, and the main charge variant of VP3 has an isoelectric point of 6.31.

### Example 13

As previous described, the viral proteins of different AAV serotypes have different a sequences. Accordingly, antibodies designed for use with one AAV serotype may not work as effectively on a different AAV serotype. The anti-VP1 pAb, anti-VP1NP2 pAb, and anti-VPINP2NP3 pAb described above in relation to Examples 11 and 12 were developed for use with AAV8 serotype AAVs. Commercially available anti-VP antibodies, such as those available for AAV2 serotype AAVs, may be less effective at characterizing viral proteins from AAV8 serotype AAVs, compared to the anti-VP antibodies described in Examples 11 and 12.

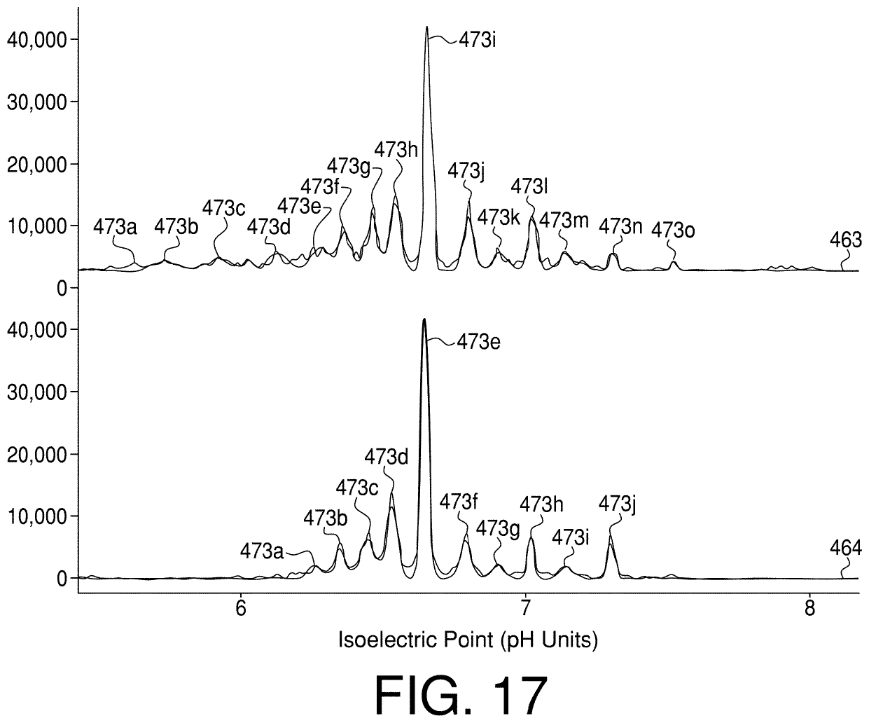

Referring to FIG. 17, charge variants profiles for a reduced and denatured analyte including an AAV8 serotype AAV were generated using an iCIEF-Western method. The charge variant profile labeled 463 was generated using the anti-VP1 pAb, anti-VP1NP2 pAb, and anti-VPINP2NP3 pAb described above in relation to Examples 11 and 12 as detection antibodies. An anti-rabbit antibody conjugated to HRP was used as a reporter molecule, and luminol-peroxide was used as a reporting agent. The charge variant profile labeled 464 was generated using commercially available anti-VP antibodies designed for AAV2 serotype AAVs.

As shown in FIG. 17, the pAbs developed for use with AAV8 serotype AAVs had greater sensitivity and detected fifteen peaks (e.g., peaks 473a-473o), compared to the ten peaks (e.g., peaks 474a-474j) detected by the commercially available antibodies.

### Example 14

Antibodies were developed with specificity for VP proteins for AAV1 serotype AAVs. Two recombinant peptides from the portion of the VP2 sequence were used as a rabbit antigen to generate a polyclonal antibody with specificity to AAV1 serotype VP2.

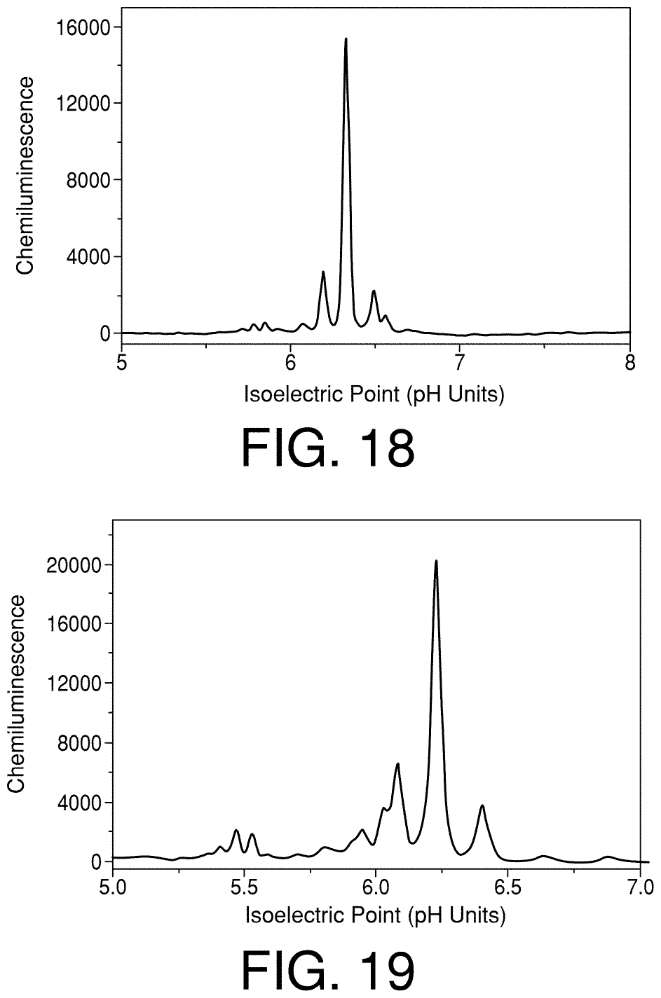

A charge variant profile for a reduced and denatured analyte including AAV1 serotype AAV was generated using an iCIEF-Western method, and is shown in FIG. 18. The polyclonal antibody with specificity to AAV1 serotype VP2 was used as the detection antibody. An anti-rabbit antibody conjugated to HRP was used as a reporter molecule, and luminol-peroxide was used as a reporting agent. As shown in FIG. 18, the polyclonal antibody with specificity to AAV1 serotype VP2 detected polypeptides in the AAV1 serotype analyte.

### Example 15

Antibodies were developed with specificity for VP proteins for AAV5 serotype AAVs. Two recombinant peptides from the portion of the VP2 sequence were used as a rabbit antigen to generate a polyclonal antibody with specificity to AAV5 serotype VP2.

A charge variant profile for a reduced and denatured analyte including AAV5 serotype AAV was generated using an iCIEF-Western method, and is shown in FIG. 19. The polyclonal antibody with specificity to AAV5 serotype VP2 was used as the detection antibody. An anti-rabbit antibody conjugated to HRP was used as a reporter molecule, and luminol-peroxide was used as a reporting agent. As shown in FIG. 19, the polyclonal antibody with specificity to AAV5 serotype VP2 detected polypeptides in the AAV5 serotype analyte.

### Example 16

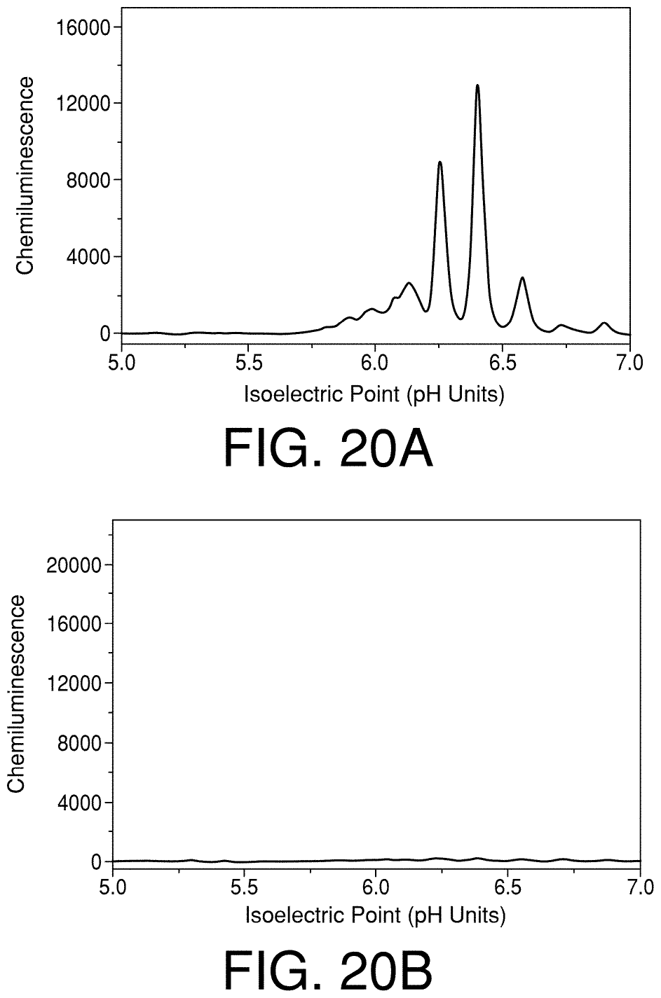

Charge variant profiles for reduced and denatured analytes including AAV8 serotype AAVs were generated using iCIEF-Western methods, and are shown in FIGS. 20A and 20B. The charge variant profile shown in FIG. 20A was generated using the polyclonal antibody with specificity to AAV1 serotype VP2 as the detection antibody. The charge variant profile shown in FIG. 20B was generated using the polyclonal antibody with specificity to AAV5 serotype VP2 as the detection antibody. For both FIGS. 20A and 20B, an anti-rabbit antibody conjugated to HRP was used as a reporter molecule, and luminol-peroxide was used as a reporting agent.

Referring to FIG. 20A, charge variant peaks were detected, indicating that the polyclonal antibody with specificity to AAV1 serotype VP2 has some sensitivity to AAV8 serotype viral proteins. Referring to FIG. 20B, charge variant peaks were not detected, indicating that the polyclonal antibody with specificity to AAV5 serotype VP2 cannot detect AAV8 serotype viral proteins.

### Example 17

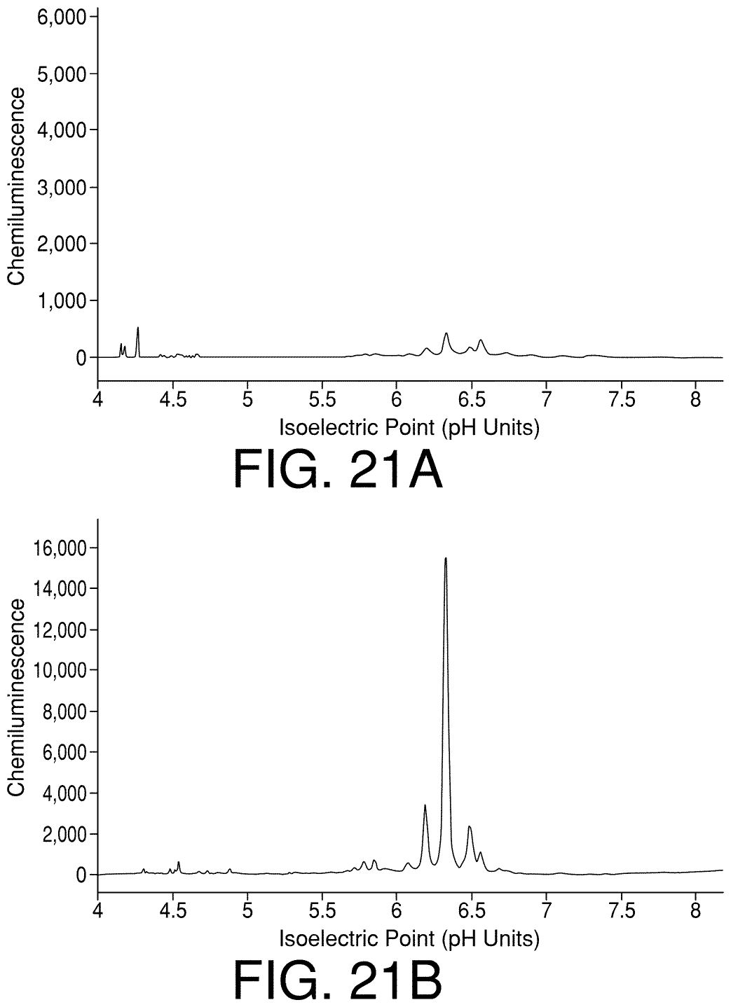

Charge variant profiles were produced for reduced and denatured analytes including an AAV1 serotype AAV, and are shown in FIGS. 21A and 21B. The charge variant profile shown in FIG. 21A was generated using the polyclonal antibody with specificity to AAV8 serotype VP2 (e.g., the anti-VP1NP2 antibody described in Examples 11 and 12) as the detection antibody. The charge variant profile shown in FIG. 21B was generated using the polyclonal antibody with specificity to AAV1 serotype VP2 as the detection antibody. For both FIGS. 21A and 21B, an anti-rabbit antibody conjugated to HRP was used as a reporter molecule, and luminol-peroxide was used as a reporting agent. As can be seen by comparing the charge variant profiles in FIGS. 21A and 21B, the polyclonal antibody with specificity to AAV8 serotype VP2 was not able to detect the AAV1 serotype VP2 protein.

### Example 18

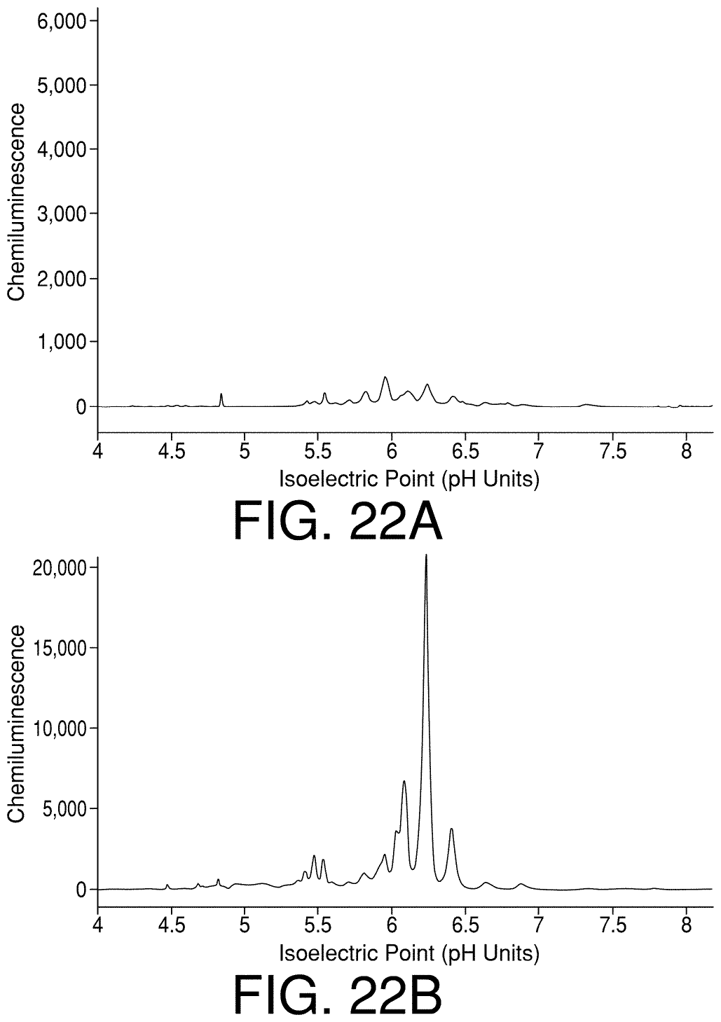

Charge variant profiles were produced for reduced and denatured analytes including an AAV1 serotype AAV, and are shown in FIGS. 22A and 22B. The charge variant profile shown in FIG. 22A was generated using the polyclonal antibody with specificity to AAV8 serotype VP2 (e.g., the anti-VP1NP2 antibody described in Examples 11 and 12) as the detection antibody. The charge variant profile shown in FIG. 22B was generated using the polyclonal antibody with specificity to AAV5 serotype VP2 as the detection antibody. For both FIGS. 22A and 22B, an anti-rabbit antibody conjugated to HRP was used as a reporter molecule, and luminol-peroxide was used as a reporting agent. As can be seen by comparing the charge variant profiles in FIGS. 22A and 22B, the polyclonal antibody with specificity to AAV8 serotype VP2 was not able to detect the AAV5 serotype VP2 protein.

### Example 19

As previously described, a charge variant profile of a lot of biopharmaceutical product may be generated to characterize environmental stress perceived by the lot. For example, charge variant profiles of thermally stressed lot and non-thermally stressed lots may be generated. Charge variant profiles of unknown lots may then be compared to the known charge variant profiles, to determine whether the unknown let was under unacceptable levels of stress.

Charge variant profiles were generated for three lots of a biopharmaceutical product including an AAV8 serotype AAV, using an iCIEF-Western method. The anti-VP1 pAb described in Examples 11 and 12 was used as the detection antibody, an anti-rabbit antibody conjugated to HRP was used as a reporter molecule, and luminol-peroxide was used as a reporting agent. The first lot (Lot A) was not under thermal stress, the second lot (Lot B) was stored at 40° C. for one week, and the third lot (Lot C) was stored at 40° C. for two weeks.

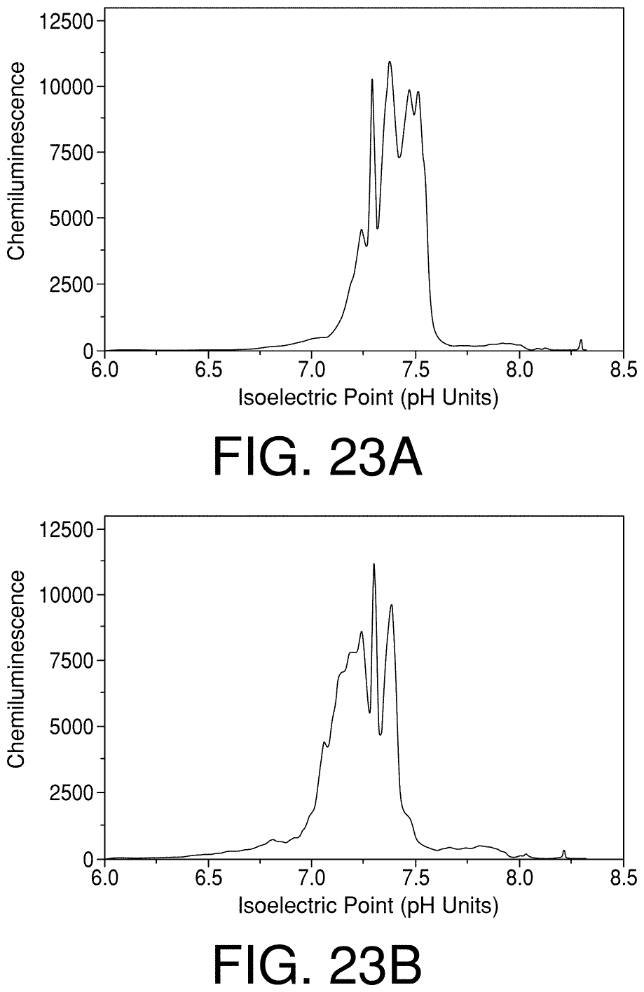

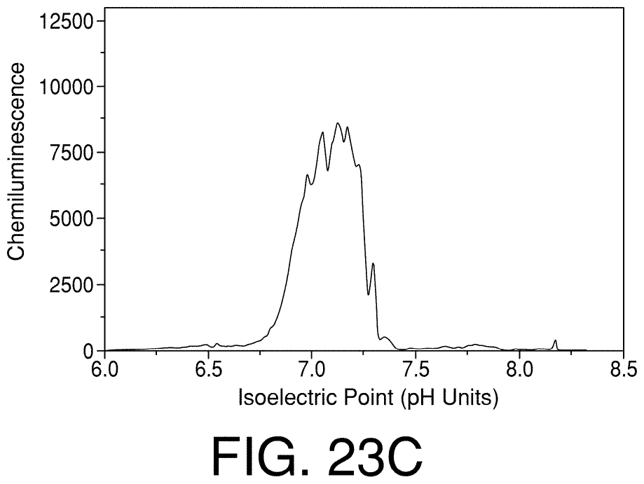

The charge variant profile of Lot A is shown in FIG. 23A, the charge variant profile of Lot B is shown in FIG. 23B, and the charge variant profile of Lot C is shown in FIG. 23C. As can been seen in FIGS. 23A-23C, there is an acidic shift in the charge variant profile as the AAVs receive more thermal stress.

### Example 20

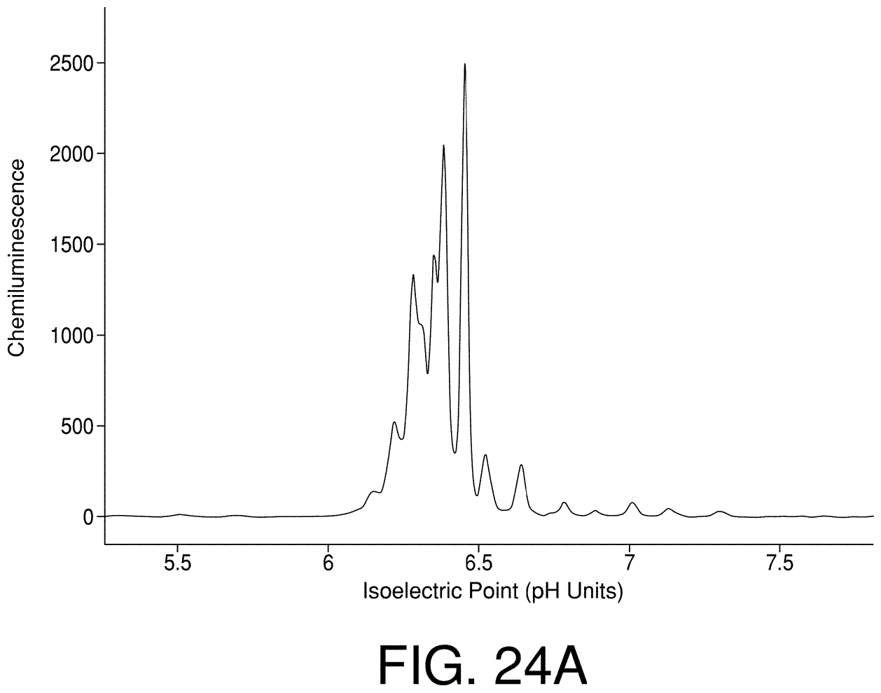

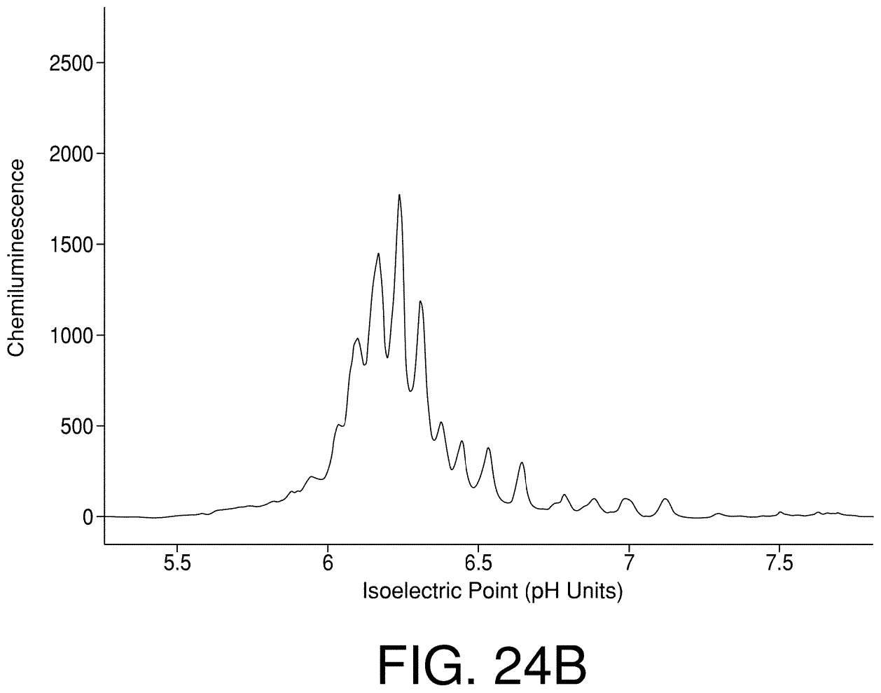

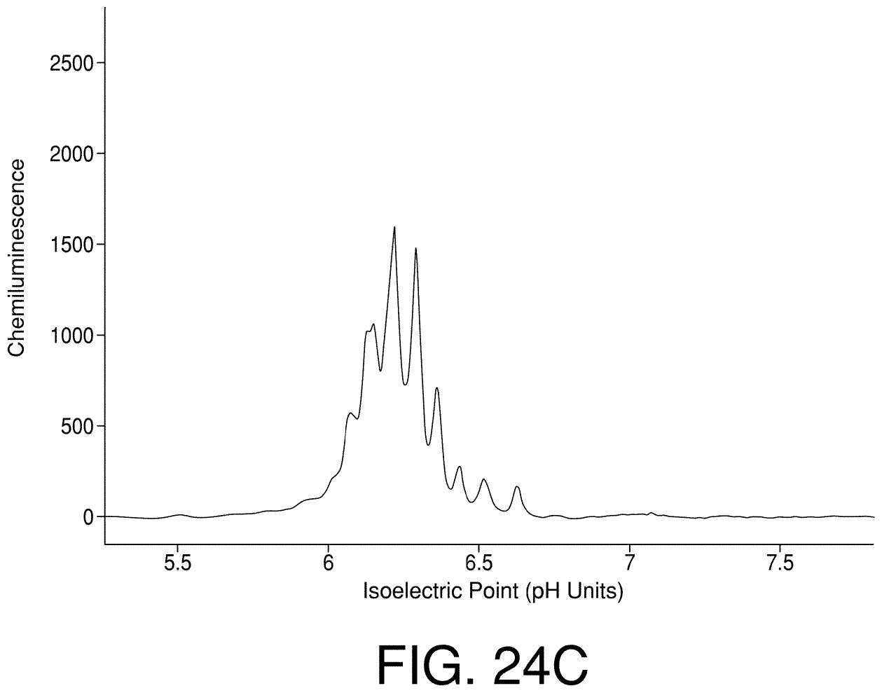

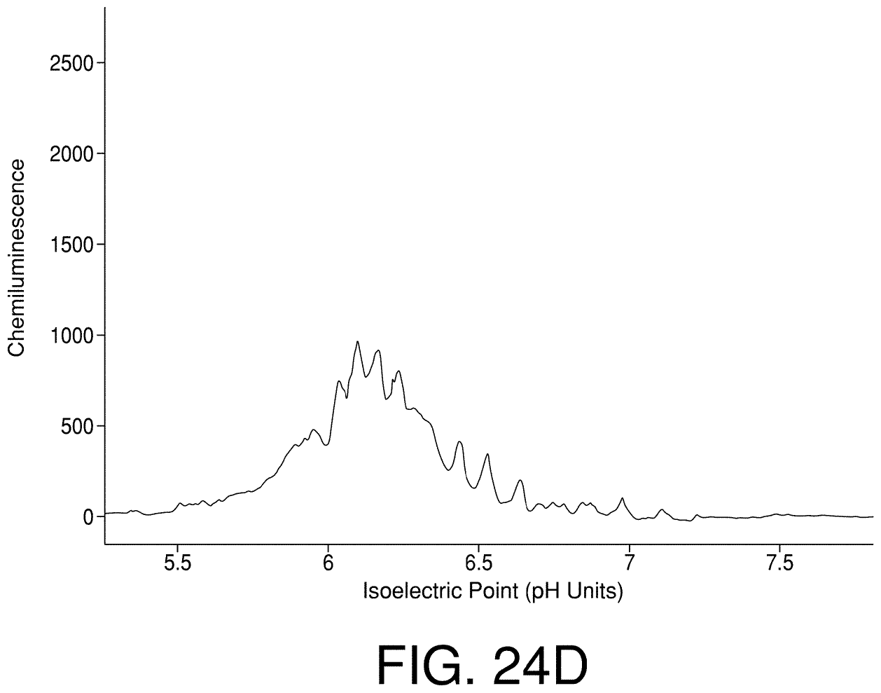

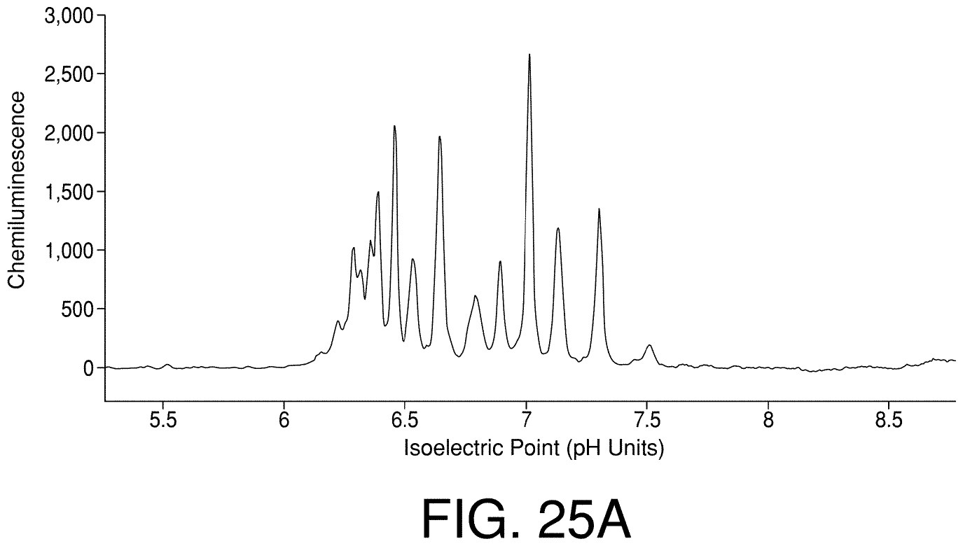

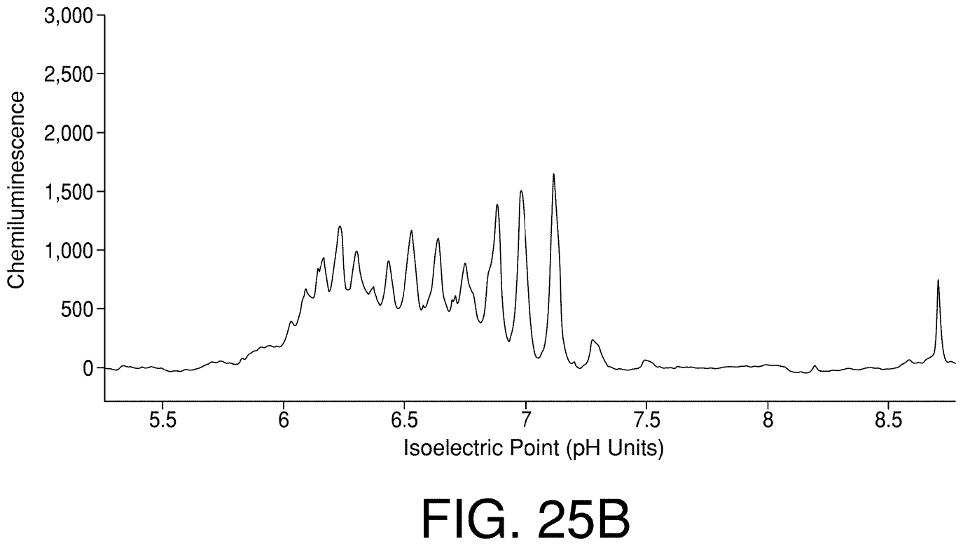

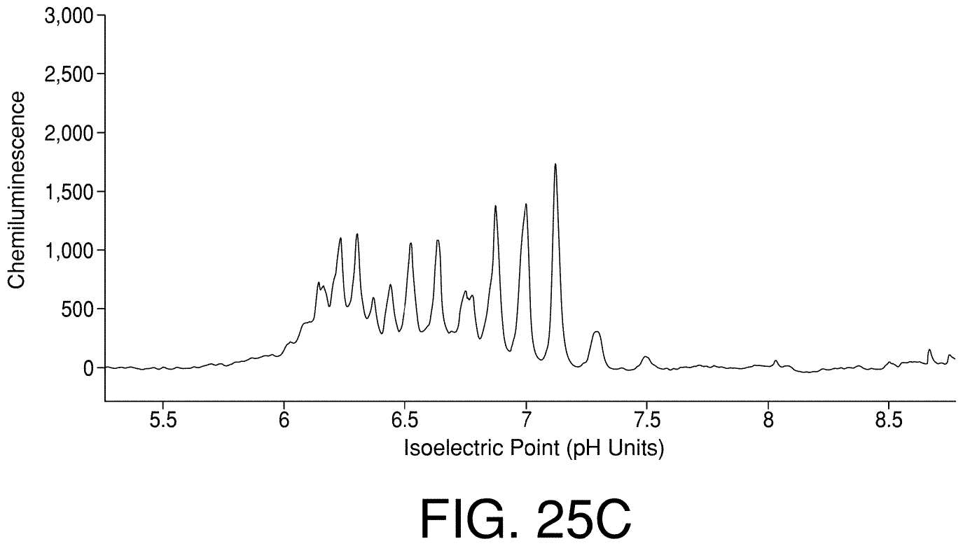

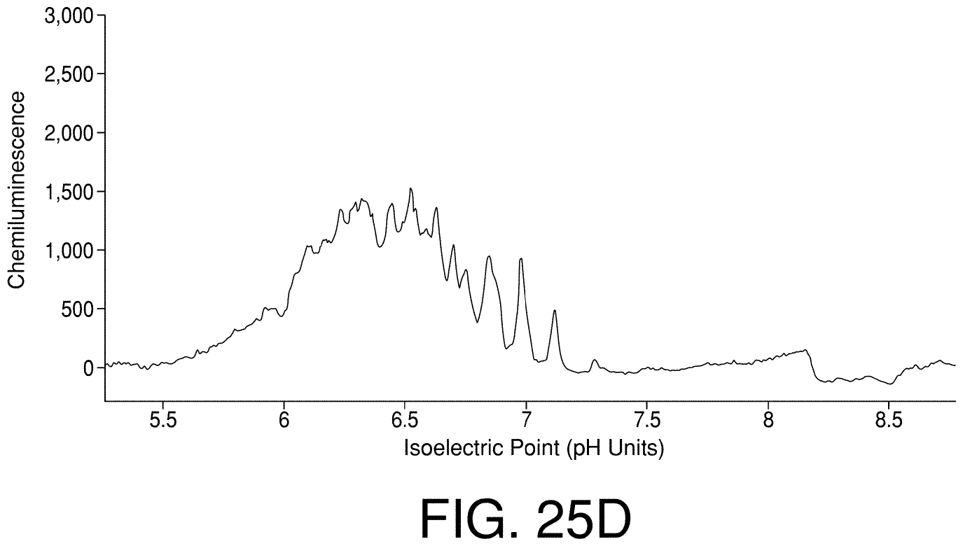

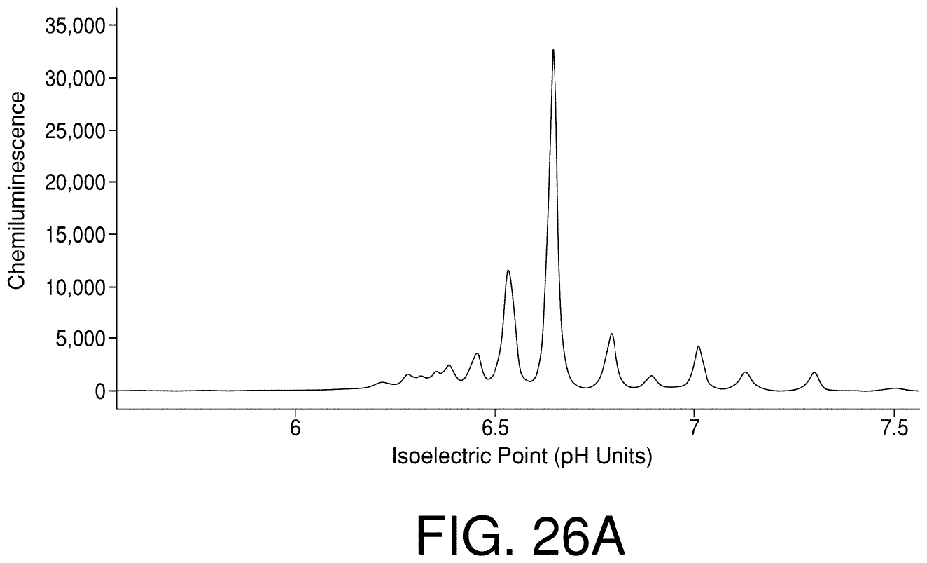

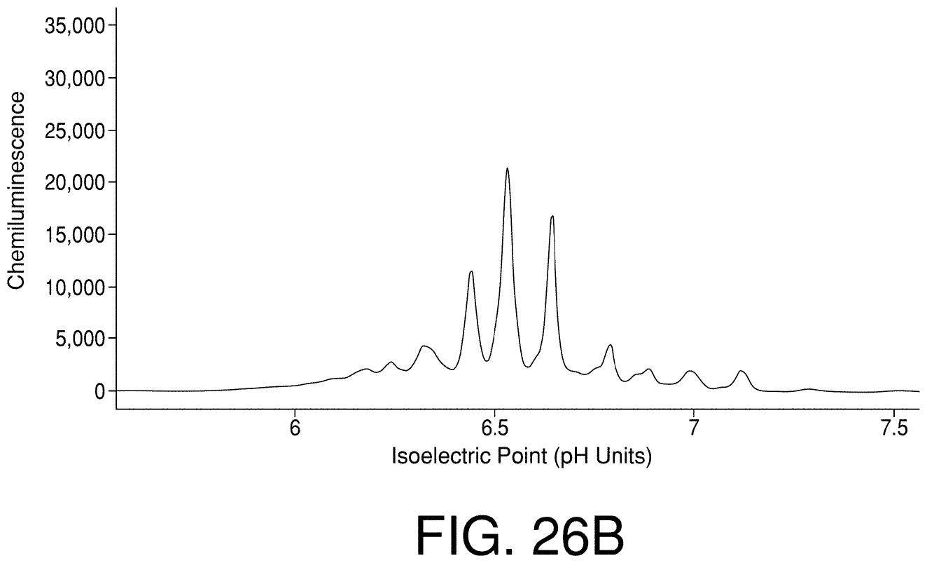

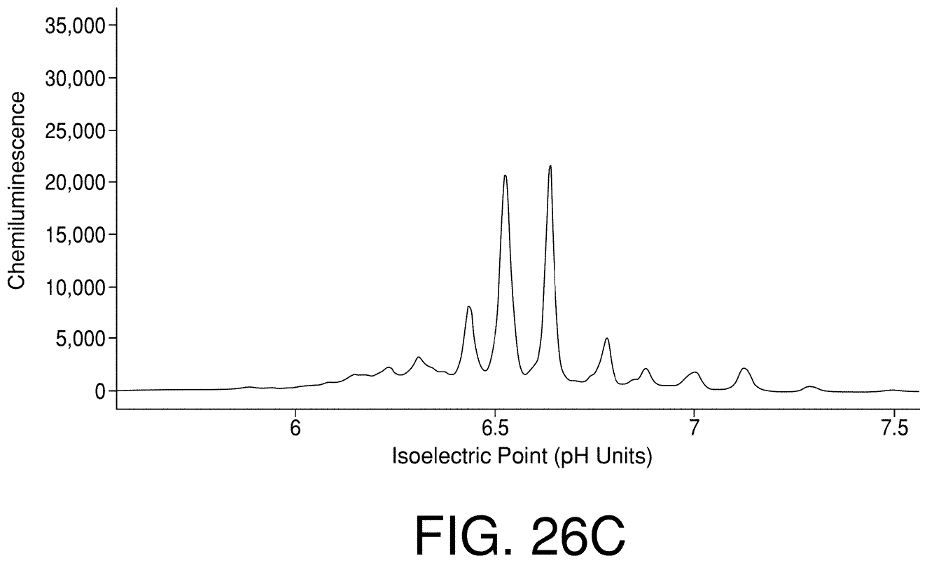

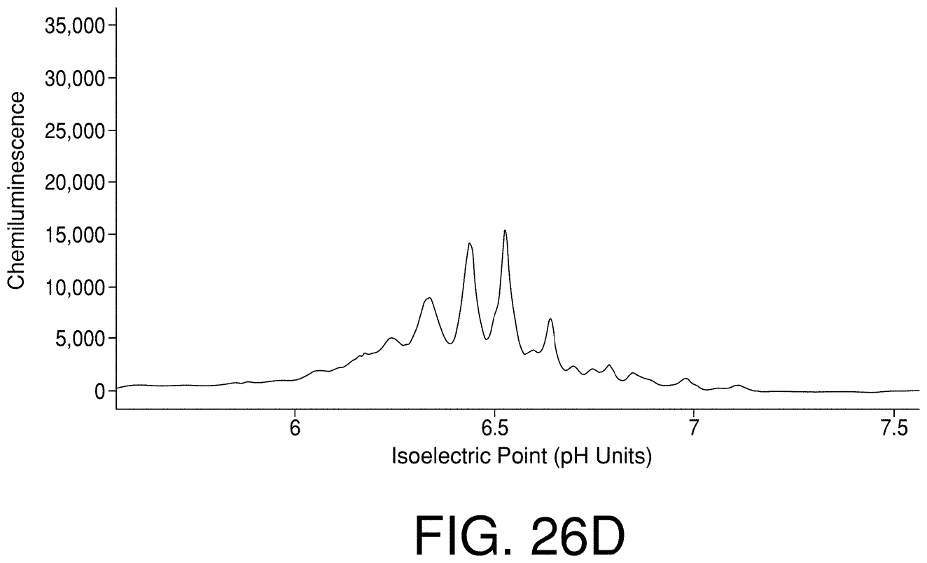

Charge variant profiles were generated for four lots of a biopharmaceutical product including an AAV8 serotype AAV, using an iCIEF-Western method. The anti-VP1 pAb, anti-VP1NP2 pAb, and anti-VPINP2NP3 pAb described in Examples 11 and 12 were used as the detection antibody, an anti-rabbit antibody conjugated to HRP was used as a reporter molecule, and luminol-peroxide was used as a reporting agent. The charge variant profiles generated using the anti-VP1 pAb as the detection antibody are shown in FIGS. 24A-24D, the charge variant profiles generated using the anti-VP1NP2 pAb as the detection antibody are shown in FIGS. 25A-25D, and the charge variant profiles generated using the anti-VPINP2NP3 pAb as the detection antibody are shown in FIGS. 26A-26D.

The first lot (Lot A) was not under thermal stress, the second lot (Lot B) was stored at 40° C. for fifteen days, the third lot (Lot C) was stored at 40° C. for one month, and the fourth lot (Lot D) was stored at 40° for two months. The charge variant profile of Lot A is shown in FIGS. 24A, 25A, and 26A; the charge variant profile of Lot B is shown in FIGS. 24B, 25B, and 26B; the charge variant profile of Lot C is shown in FIGS. 24C, 25C, and 26C; and the charge variant profile of Lot D is shown in FIGS. 24D, 25D, and 26D. As can been seen in FIGS. 24A-26D, there is an acidic shift in the charge variant profile as the AAVs receive more thermal stress. Additionally, some peaks corresponding to VP1 charge variants appear to not diminish under thermal stress.

### Example 21

As previously described, use of a combination of anti-VP pAb may enable to detection of charge variants of a single viral protein. In some embodiments, monitoring the charge variant profiles of a single viral protein may be more useful in determining the environmental stress of a lot of biopharmaceutical products, compared to monitoring the charge variant profile of all viral proteins.

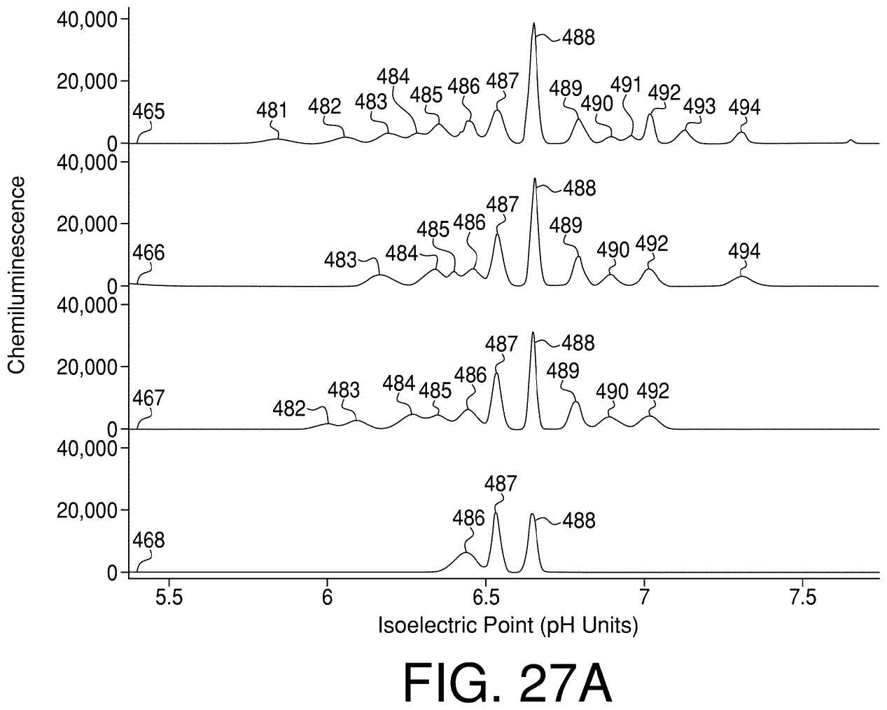

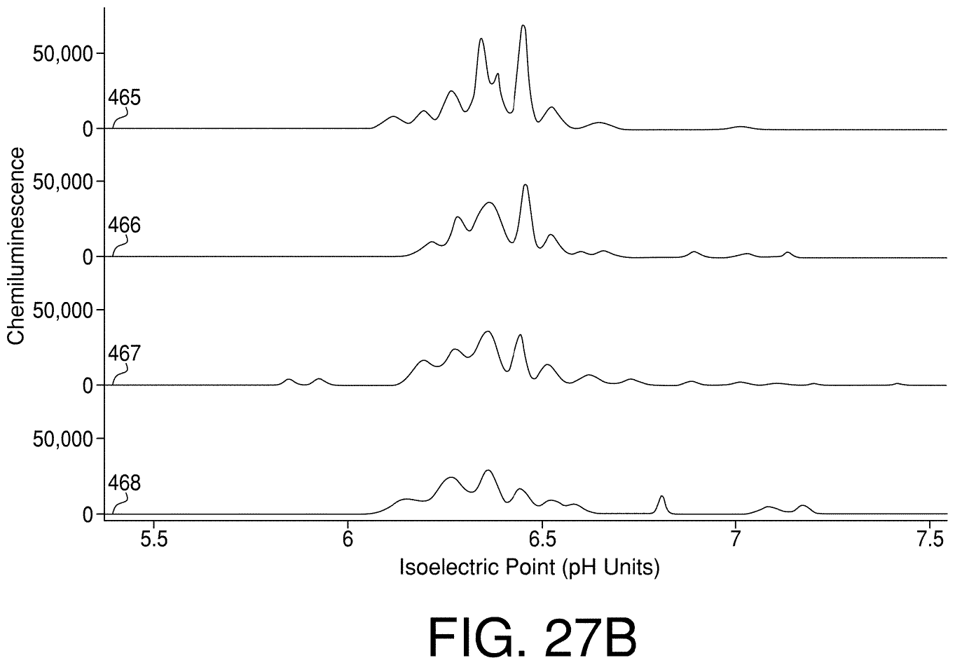

Referring to FIG. 27A, charge variant profiles were generated for four lots of analyte including reduced and denatured AAV. The first lot (Lot A) was not under thermal stress, the second lot (Lot B) was stored at 40° C. for fifteen days, the third lot (Lot C) was stored at 40° C. for one month, and the fourth lot (Lot D) was stored at 40° for two months. The anti-VP1/VP2NP3 pAb described in Examples 11 and 12 was used as the detection antibody, an anti-rabbit antibody conjugated to HRP was used as a reporter molecule, and luminol-peroxide was used as a reporting agent. The charge variant profile of Lot A is shown by line 465, the charge variant profile of Lot B is shown by line 466, the charge variant profile of Lot C is shown by line 467, and the charge variant profile of Lot D is shown by line 468.

Still referring to FIG. 27A, there is an acidic shift in the charge variant profile, as the AAV is subjected to more thermal stress. For example, the height (e.g., and area) of peak 488 decreases as the level of thermal stress increases, and the height of peak 487 increases as the level of thermal stress increases. In some instances, based on the data shown in FIG. 27A, the relative peak areas of peak 488 and 487 could be used to determine the level of environmental stress of an unknown lot.

Referring to FIG. 27B, charge variant profiles were generated for Lots A, B, C, and D of the analyte including reduced and denatured AAV. The anti-VP1 pAb described in Examples 11 and 12 was used as the detection antibody, an anti-rabbit antibody conjugated to HRP was used as a reporter molecule, and luminol-peroxide was used as a reporting agent. The charge variant profile of Lot A is shown by line 465, the charge variant profile of Lot B is shown by line 466, the charge variant profile of Lot C is shown by line 467, and the charge variant profile of Lot D is shown by line 468. The charge variant profiles shown in FIG. 27B show the same acidic shift shown in FIG. 27A.

### Example 22

Other than thermal stress, charge variant profiles generated using iCIEF-methods may be used to assess the effect of other manufacturing or storage conditions on the effectiveness of a biopharmaceutical product including a polypeptide.

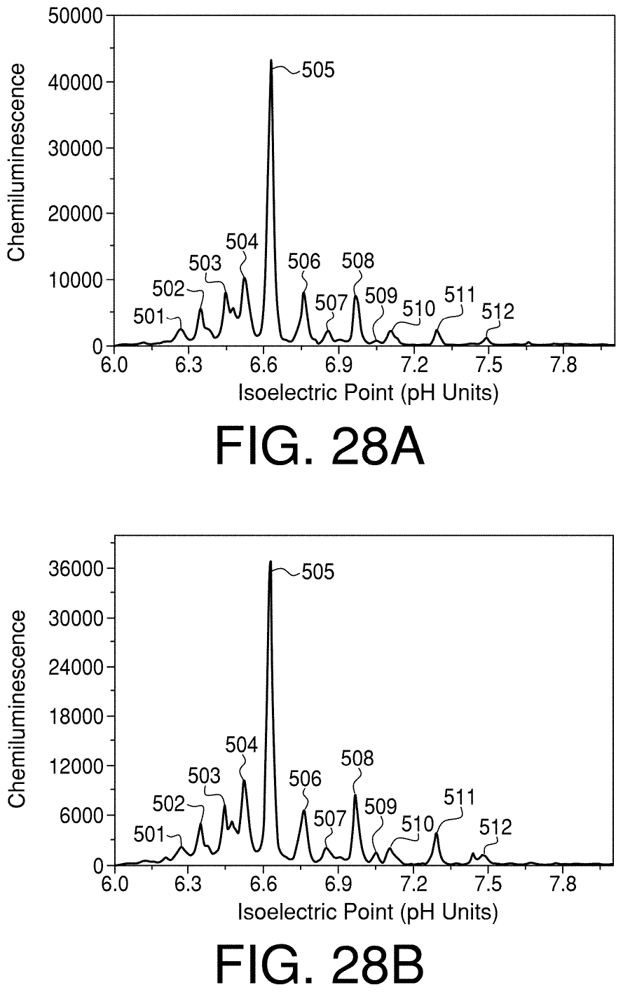

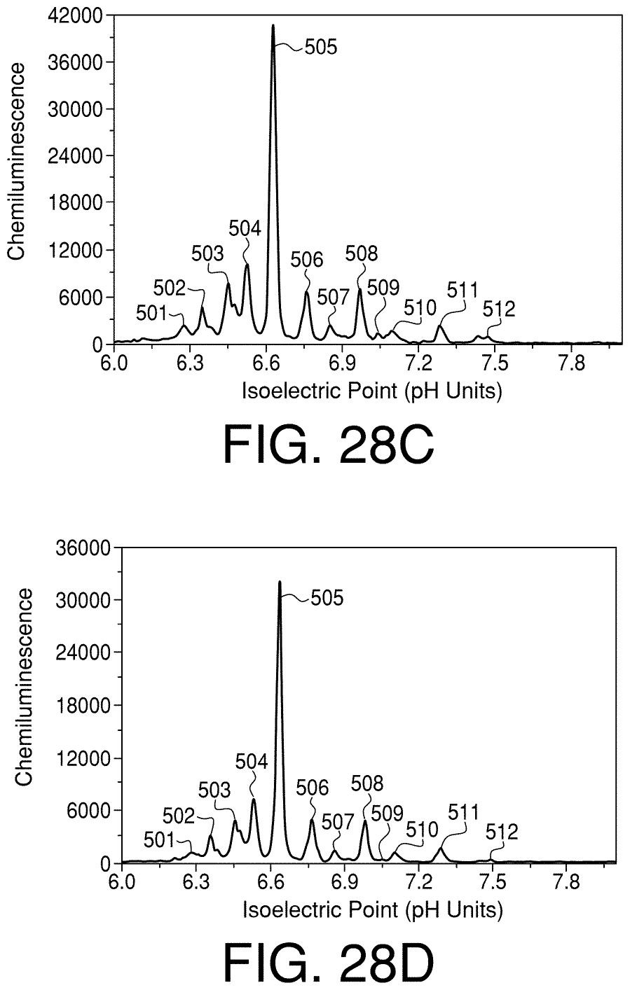

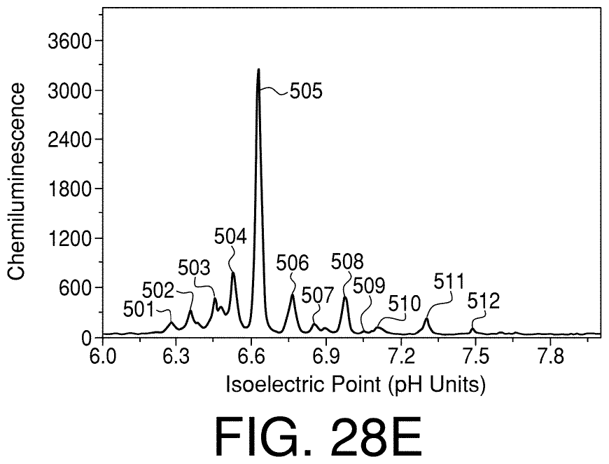

Charge variant profiles of five different lots of reduced and denatured analytes including a biopharmaceutical product comprising an AAV were generated using iCIEF-Western methods. The first lot (Lot A) was not subjected to a hold time during manufacture, the second lot (Lot B) was subjected to an eight hour process hold time during manufacture, the third lot (Lot C) was subjected to a 24 hour process hold time during manufacture, the fourth lot (Lot D) was subjected to a 48 hour hold time during manufacture, and the fifth lot (Lot E) was subjected to a 72 hour hold time during manufacture. The charge variant profile for Lot A is shown in FIG. 28A, the charge variant profile for Lot B is shown in FIG. 28B, the charge variant profile for Lot C is shown in FIG. 28C, the charge variant profile for Lot D is shown in FIG. 28D, and the charge variant profile for Lot E is shown in FIG. 28E. Peaks 501, 502, 503, 504, 505, 506, 507, 508, 509, 510, 511, and 512 each correspond to a different charge variant and are labeled in FIGS. 28A-28E.

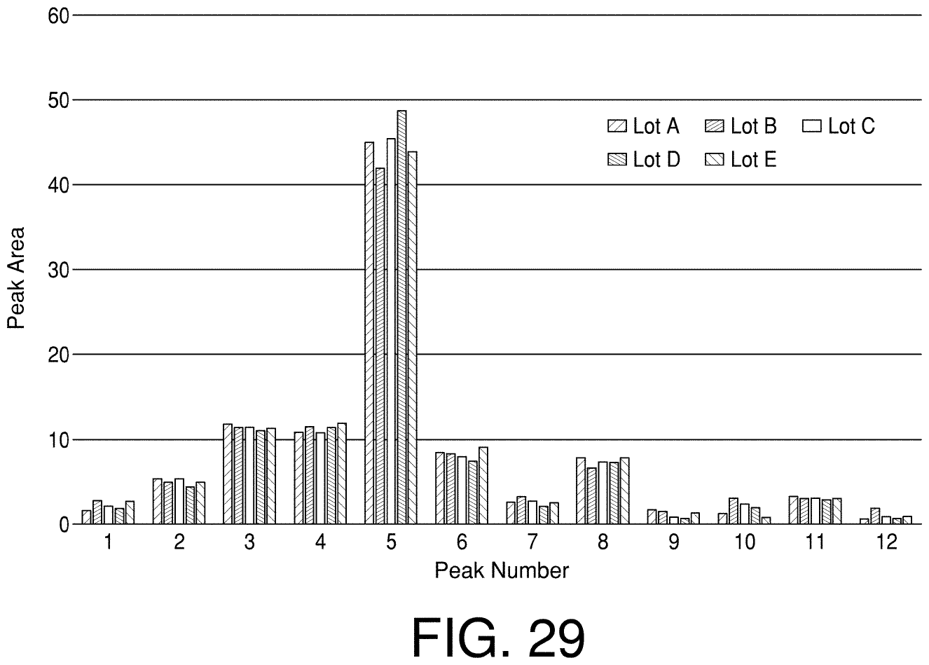

Relative peak areas were calculated for each peak of each charge variant profile. The calculated relative peak areas are summarized in FIG. 29.

### Example 23

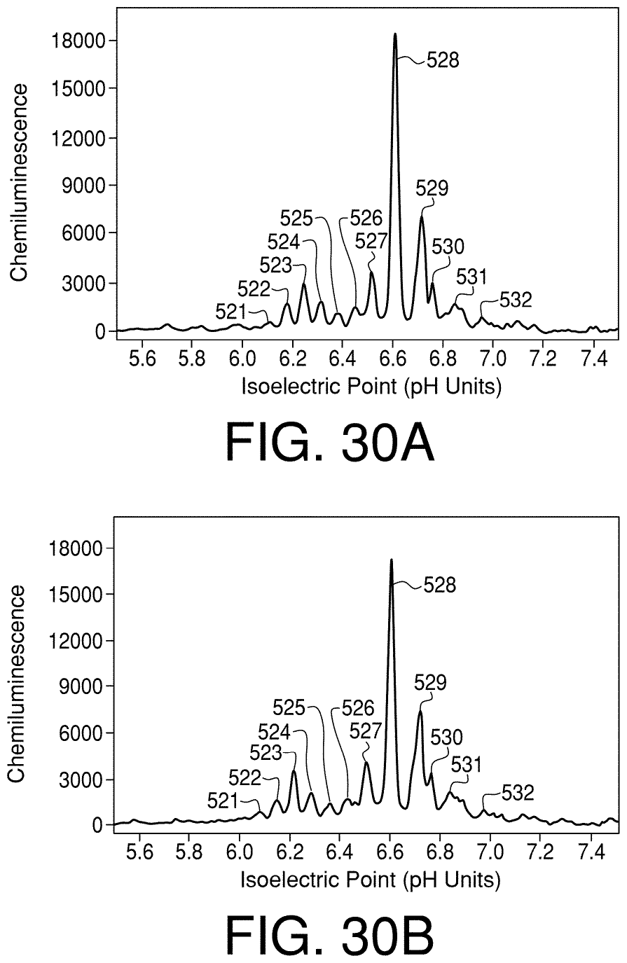

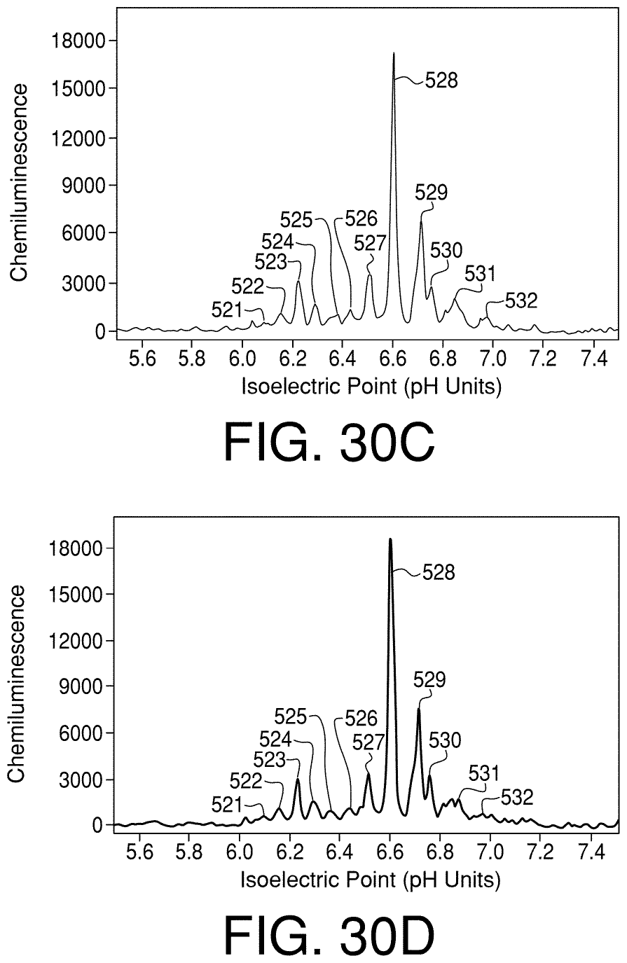

Charge variant profiles of four different lots of reduced and denatured analytes including a biopharmaceutical product comprising an AAV were generated using iCIEF-Western methods. The first lot (Lot A) was subjected to one freeze-thaw cycle (e.g., the biopharmaceutical product was frozen, then thawed), the second lot (Lot B) was subjected to one freeze-thaw cycle and held at 4° C. for seven days, the third lot (Lot C) was subjected to a three freeze-thaw cycles, and the fourth lot (Lot D) was subjected to five freeze-thaw cycles. The charge variant profile for Lot A is shown in FIG. 30A, the charge variant profile for Lot B is shown in FIG. 30B, the charge variant profile for Lot C is shown in FIG. 30C, and the charge variant profile for Lot D is shown in FIG. 30D. Peaks 521, 522, 523, 524, 525, 526, 527, 528, 529, 530, 531, and 532 each correspond to a different charge variant and are labeled in FIGS. 30A-30D.

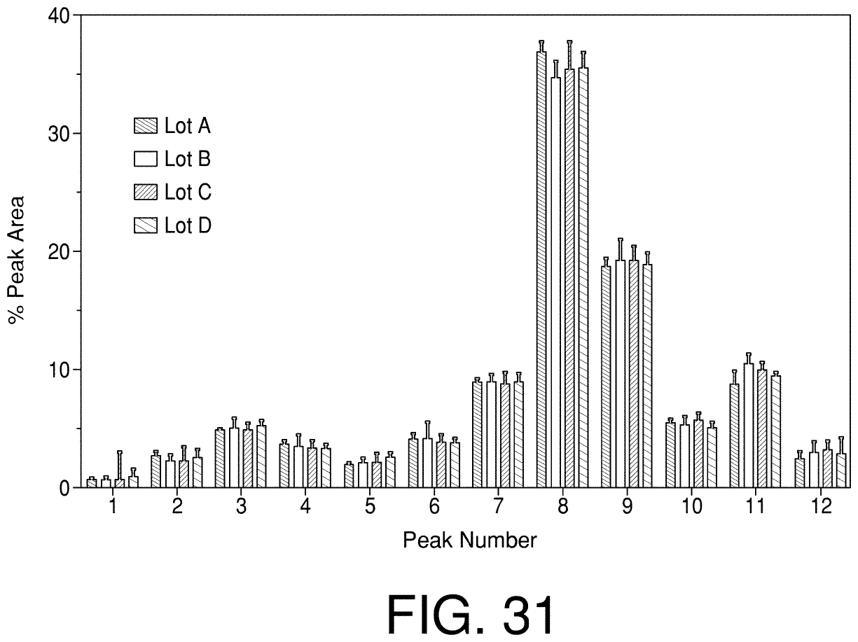

Relative peak areas were calculated for each peak of each charge variant profile. The calculated relative peak areas are summarized in FIG. 31.

### Example 24

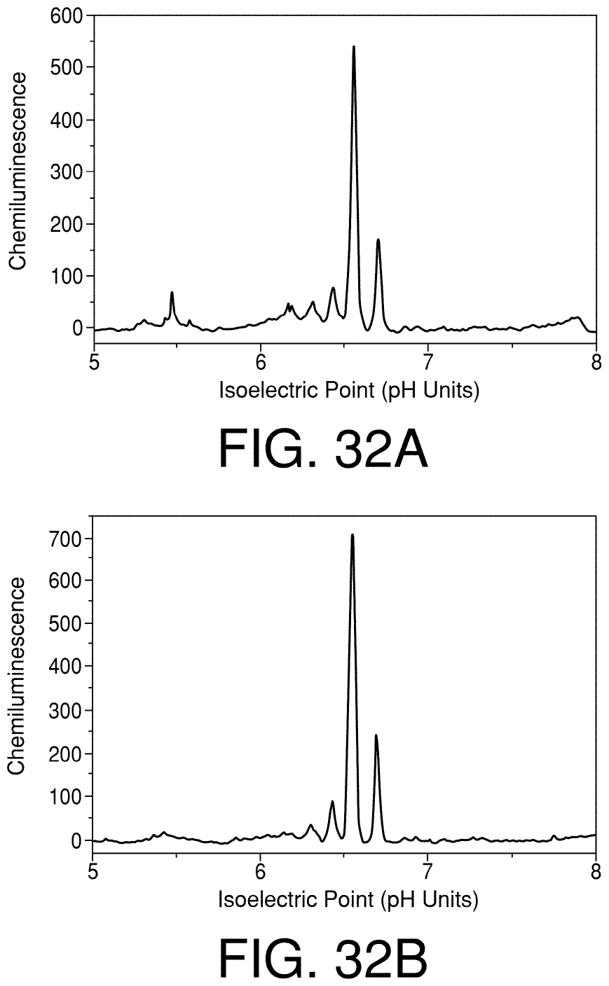

Charge variant profiles for an analyte including empty capsid AAVs were prepared according to two different iCIEF-Western methods. The first iCIEF-Western method included a sample buffer comprising a relatively low amount of urea, and the charge variant profile generated from that method is shown in FIG. 32A. The second iCIEF-Western method included a sample buffer comprising at least 6M urea, and the charge variant profile generated from that method is shown in FIG. 32B.

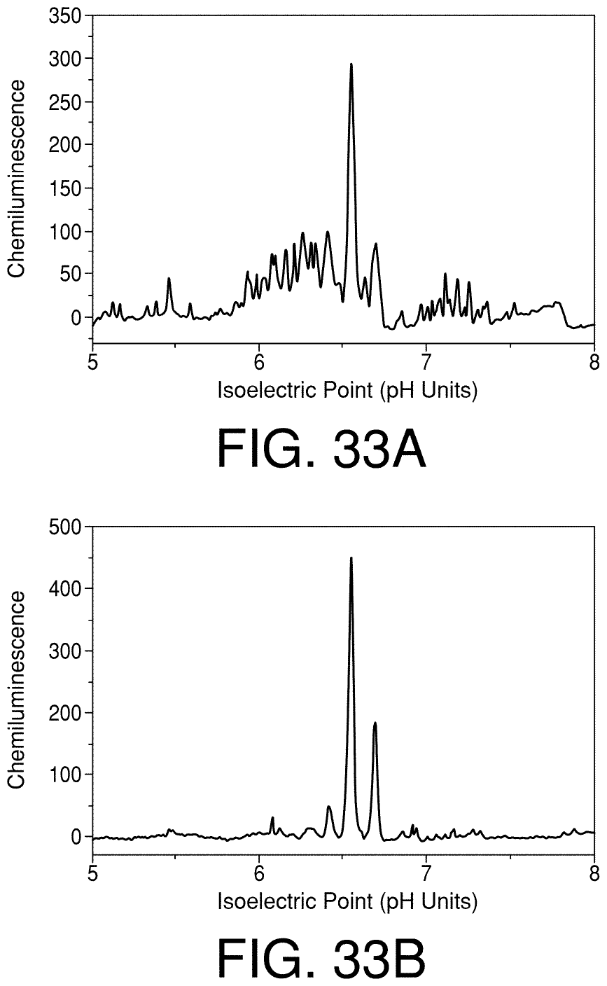

Charge variant profiles for an analyte including partially full capsid AAVs were prepared according to two different iCIEF-Western methods. The first iCIEF-Western method included a sample buffer comprising a relatively low amount of urea, and the charge variant profile generated from that method is shown in FIG. 33A. The second iCIEF-Western method included a sample buffer comprising at least 6M urea, and the charge variant profile generated from that method is shown in FIG. 33B.

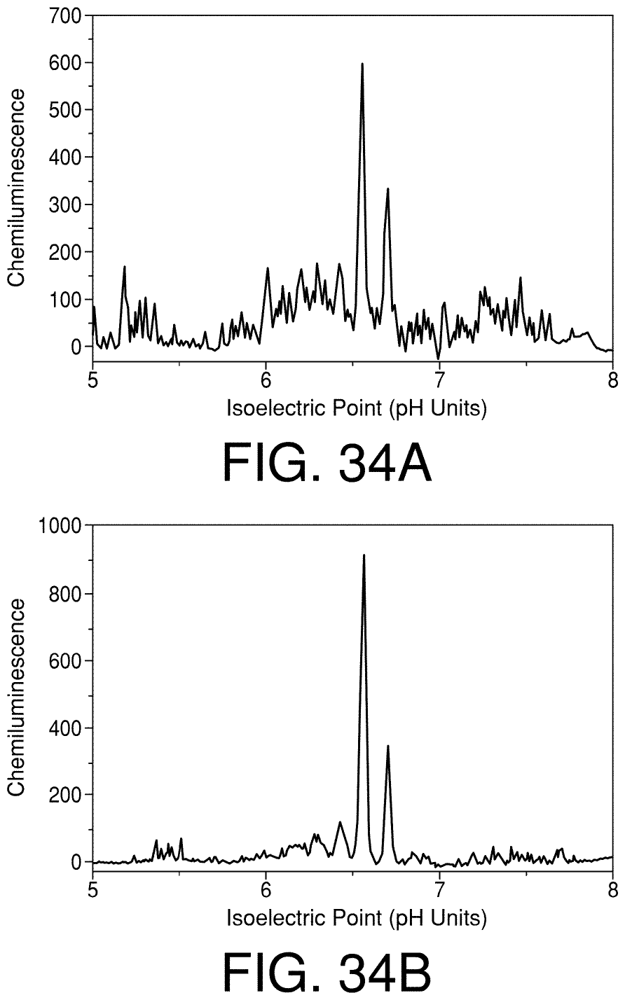

Charge variant profiles for an analyte including full capsid AAVs were prepared according to two different iCIEF-Western methods. The first iCIEF-Western method included a sample buffer comprising a relatively low amount of urea, and the charge variant profile generated from that method is shown in FIG. 34A. The second iCIEF-Western method included a sample buffer comprising at least 6M urea, and the charge variant profile generated from that method is shown in FIG. 34B.

In comparing the charge variant profiles of FIGS. 32A, 33A, and 34A with the charge variant profiles of FIGS. 32B, 33B, 34B, less baseline noise is observed, and therefore, a better signal-to-noise ratio is achieved with a sample buffer including a higher urea concentration.

### Example 25

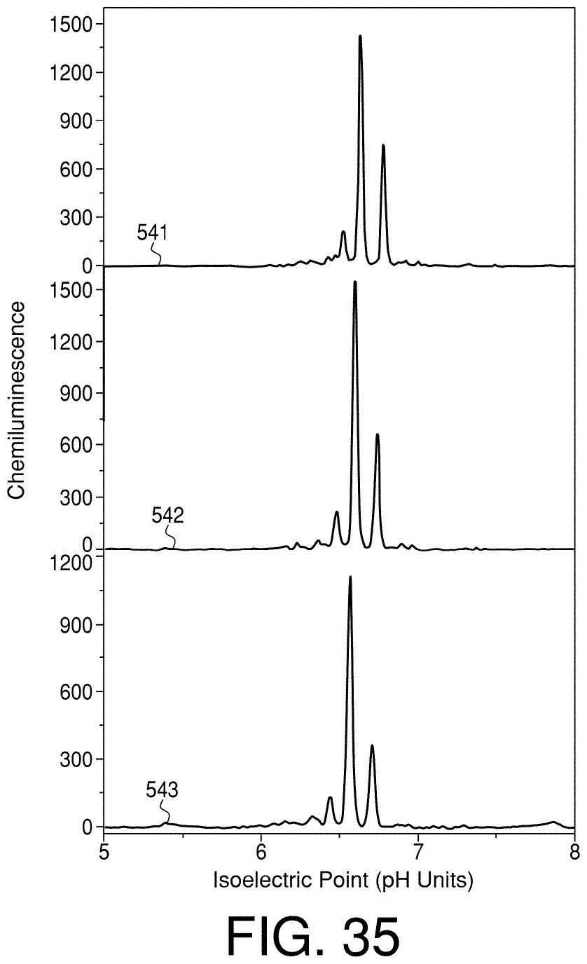

Charge variant profiles for an analyte including empty capsid AAVs were prepared according to three different iCIEF-Western methods. The first iCIEF-Western method included a sample buffer comprising approximately 4.3 M urea and approximately 30 vol. % formamide, and the charge variant profile generated from that method is represented by line 541 in FIG. 35. The second iCIEF-Western method included a sample buffer comprising approximately 5.6 M urea and approximately 15 vol. % formamide, and the charge variant profile generated from that method is represented by line 542 in FIG. 35. The third iCIEF-Western method included a sample buffer comprising approximately 7.3 M urea and approximately 0 vol. % formamide, and the charge variant profile generated from that method is represented by line 543 in FIG. 35.

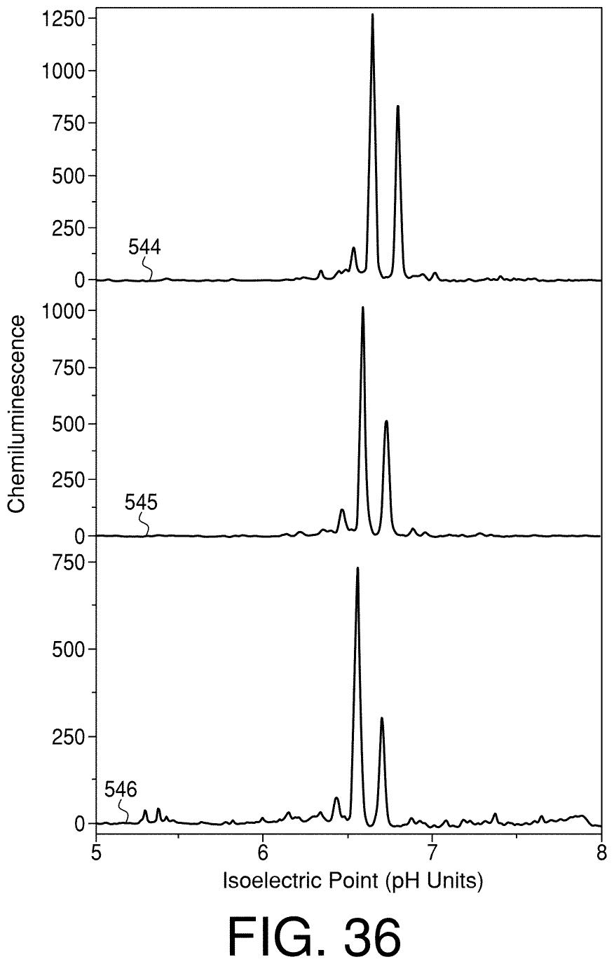

Charge variant profiles for an analyte including partially full capsid AAVs were prepared according to three different iCIEF-Western methods. The first iCIEF-Western method included a sample buffer comprising approximately 4.3 M urea and approximately 30 vol. % formamide, and the charge variant profile generated from that method is represented by line 544 in FIG. 36. The second iCIEF-Western method included a sample buffer comprising approximately 5.6 M urea and approximately 15 vol. % formamide, and the charge variant profile generated from that method is represented by line 545 in FIG. 36. The third iCIEF-Western method included a sample buffer comprising approximately 7.3 M urea and approximately 0 vol. % formamide, and the charge variant profile generated from that method is represented by line 546 in FIG. 36.

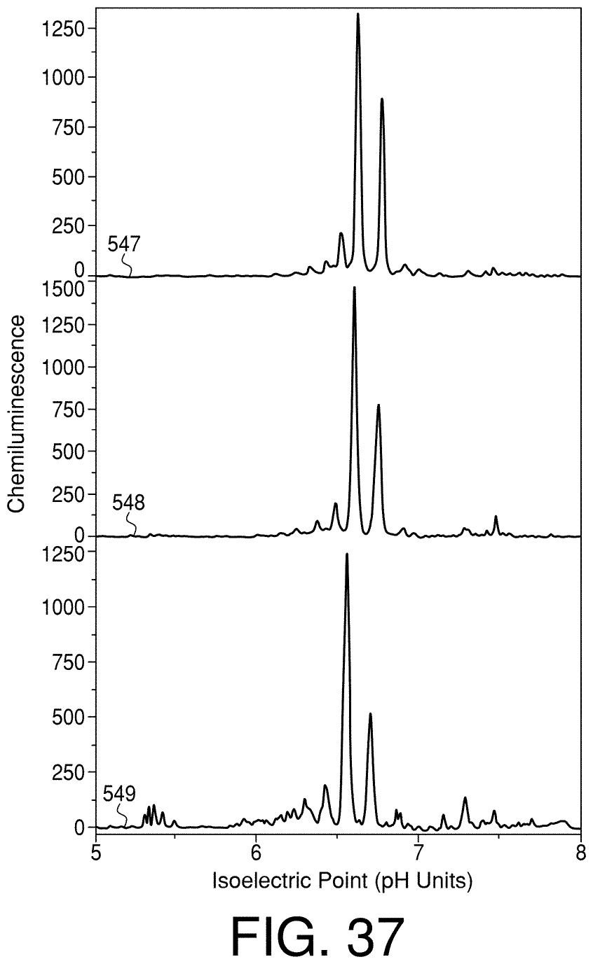

Charge variant profiles for an analyte including full capsid AAVs were prepared according to three different iCIEF-Western methods. The first iCIEF-Western method included a sample buffer comprising approximately 4.3 M urea and approximately 30 vol. % formamide, and the charge variant profile generated from that method is represented by line 547 in FIG. 37. The second iCIEF-Western method included a sample buffer comprising approximately 5.6 M urea and approximately 15 vol. % formamide, and the charge variant profile generated from that method is represented by line 548 in FIG. 37. The third iCIEF-Western method included a sample buffer comprising approximately 7.3 M urea and approximately 0 vol. % formamide, and the charge variant profile generated from that method is represented by line 549 in FIG. 37.

In comparing the charge variant profiles of FIGS. 35-37, less baseline noise is observed, and therefore, a better signal-to-noise ratio is achieved with a sample buffer including formamide in the presence of urea.

The present disclosure is further described by the following non-limiting items.

Item 1. A method of quantifying a charge variant within an analyte, the method comprising:
introducing the analyte into a capillary;
separating charge variants within the sample buffer along an isoelectric gradient;
incubating the capillary in a detection antibody; and
quantifying a relative abundance of a charge variant based on a signal that corresponds to the detection antibody.

Item 2. The method of item 1, further comprising incubating the capillary in a reporter molecule.

Item 3. The method of item 2, wherein the reporter molecule comprises an antibody conjugated to horseradish peroxidase or streptavidin conjugated to horseradish peroxidase.

Item 4. The method of item 2, further comprising introducing a detection agent into the capillary.

Item 5. The method of item 4, wherein the detection agent is luminol-peroxide.

Item 6. The method of item 2, further comprising, generating an electropherogram, wherein the electropherogram includes a plot of a strength of a chemiluminescent signal generated by the reporter molecule versus an isoelectric point along the isoelectric gradient where the chemiluminescent signal was detected.

Item 7. The method of item 6, wherein quantifying the relative abundance of the charge variant based on the signal that corresponds to the detection antibody includes calculating an area under a peak of the electropherogram that corresponds to the charge variant.

Item 8. The method of item 1, further comprising, after separating charge variants along the isoelectric gradient, and prior to incubating the capillary in the detection antibody: immobilizing charge variants within the capillary.

Item 9. A method of quantifying a charge variant within an analyte, the method comprising: reducing and denaturing polypeptides within the analyte to generate reduced and denatured polypeptides, wherein the analyte includes charge variants of a target polypeptide;
buffer exchanging the reduced and denatured polypeptides to generate a buffer exchanged sample, wherein the buffer exchanged sample includes the reduced and denatured polypeptides;
preparing a sample buffer including the buffer exchanged sample;
introducing the sample buffer into a capillary;
separating charge variants of the target polypeptide along an isoelectric gradient; and
measuring a signal that is correlated to an abundance of the target polypeptide at a region within the isoelectric gradient within the capillary.

Item 10. The method of item 9, wherein the sample buffer includes urea, carrier ampholytes, and a cellulose.

Item 11. The method of item 10, wherein the cellulose is hydroxyl propyl methyl cellulose, and the sample buffer includes at least approximately 1 volume percent hydroxyl propyl methyl cellulose.

Item 12. The method of item 10, wherein the sample buffer includes a urea concentration of at least approximately 6 M.

Item 13. The method of item 12, wherein the urea concentration of the sample buffer is at least approximately 8 M.

Item 14. The method of item 9, wherein the sample buffer includes formamide.

Item 15. The method of item 14, wherein a formamide concentration within the sample is less than or equal to approximately 30 volume percent.

Item 16. A method of assessing a level of environmental stress perceived by a sample of a target polypeptide, the method comprising:
generating a charge variant profile for the sample, wherein the charge variant profile includes a plurality of peaks, and where each peak:
   is associated with a corresponding charge variant of the target polypeptide;
   is associated with an isoelectric point that is equivalent to the isoelectric point of the corresponding charge variant of the target polypeptide; and
   includes a relative peak area that is associated with a relative abundance of the corresponding charge variant of the target polypeptide;
comparing the charge variant profile for the sample to one or more known charge variant profiles; and
based on the comparison of the charge variant profile for the sample to the one or more known charge variant profiles, determining a level of environmental stress perceived by the sample.

Item 17. The method of item 16, wherein the level of environmental stress is associated with a level of thermal stress, a level of stress due to a manufacturing process hold time, or a level of stress due to freeze-thaw cycles.

Item 18. The method of item 16, wherein the target polypeptide includes an antibody or an adeno-associated virus.

Item 19. The method of item 16, wherein generating the charge variant profile for the sample includes:
introducing the sample into a capillary; and
separating charge variants of the target polypeptide along an isoelectric gradient.

Item 20. The method of item 19, wherein generating the charge variant profile for the sample further includes:
incubating the capillary in a detection antibody;
incubating the capillary in a reporter molecule; and generating an electropherogram, wherein the electropherogram includes a plot of a strength of a signal generated by the reporter molecule versus an isoelectric point along the isoelectric gradient where the signal was detected.

Those skilled in the art will appreciate that the conception upon which this disclosure is based may readily be used as a basis for designing other methods and systems for carrying out the several purposes of the present disclosure. Accordingly, the claims are not to be considered limited by the foregoing description.

What is claimed is:

1. A method of quantifying a charge variant within an analyte, the method comprising:
introducing the analyte into a capillary;
separating charge variants within the sample buffer along an isoelectric gradient;
incubating the capillary in a detection antibody; and
quantifying a relative abundance of a charge variant based on a signal that corresponds to the detection antibody.

2. The method of claim 1, further comprising incubating the capillary in a reporter molecule.

3. The method of claim 2, wherein the reporter molecule comprises an antibody conjugated to horseradish peroxidase or streptavidin conjugated to horseradish peroxidase.

4. The method of claim 2, further comprising introducing a detection agent into the capillary.

5. The method of claim 4, wherein the detection agent is luminol-peroxide.

6. The method of claim 2, further comprising, generating an electropherogram, wherein the electropherogram includes a plot of a strength of a chemiluminescent signal generated by the reporter molecule versus an isoelectric point along the isoelectric gradient where the chemiluminescent signal was detected.

7. The method of claim 6, wherein quantifying the relative abundance of the charge variant based on the signal that corresponds to the detection antibody includes calculating an area under a peak of the electropherogram that corresponds to the charge variant.

8. The method of claim 1, further comprising, after separating charge variants along the isoelectric gradient, and prior to incubating the capillary in the detection antibody:
immobilizing charge variants within the capillary.

9. A method of quantifying a charge variant within an analyte, the method comprising:
reducing and denaturing polypeptides within the analyte to generate reduced and denatured polypeptides, wherein the analyte includes charge variants of a target polypeptide;
buffer exchanging the reduced and denatured polypeptides to generate a buffer exchanged sample, wherein the buffer exchanged sample includes the reduced and denatured polypeptides;
preparing a sample buffer including the buffer exchanged sample;
introducing the sample buffer into a capillary;
separating charge variants of the target polypeptide along an isoelectric gradient; and
measuring a signal that is correlated to an abundance of the target polypeptide at a region within the isoelectric gradient within the capillary.

10. The method of claim 9, wherein the sample buffer includes urea, carrier ampholytes, and a cellulose.

11. The method of claim 10, wherein the cellulose is hydroxyl propyl methyl cellulose, and the sample buffer includes at least approximately 1 volume percent hydroxyl propyl methyl cellulose.

12. The method of claim 10, wherein the sample buffer includes a urea concentration of at least approximately 6 M.

13. The method of claim 12, wherein the urea concentration of the sample buffer is at least approximately 8 M.

14. The method of claim 9, wherein the sample buffer includes formamide.

15. The method of claim 14, wherein a formamide concentration within the sample is less than or equal to approximately 30 volume percent.

16. A method of assessing a level of environmental stress perceived by a sample of a target polypeptide, the method comprising:
generating a charge variant profile for the sample, wherein the charge variant profile includes a plurality of peaks, and where each peak:
is associated with a corresponding charge variant of the target polypeptide;
is associated with an isoelectric point that is equivalent to the isoelectric point of the corresponding charge variant of the target polypeptide; and
includes a relative peak area that is associated with a relative abundance of the corresponding charge variant of the target polypeptide;
comparing the charge variant profile for the sample to one or more known charge variant profiles; and
based on the comparison of the charge variant profile for the sample to the one or more known charge variant profiles, determining a level of environmental stress perceived by the sample.

17. The method of claim 16, wherein the level of environmental stress is associated with a level of thermal stress, a level of stress due to a manufacturing process hold time, or a level of stress due to freeze-thaw cycles.

18. The method of claim 16, wherein the target polypeptide includes an antibody or an adeno-associated virus.

19. The method of claim 16, wherein generating the charge variant profile for the sample includes:
introducing the sample into a capillary; and
separating charge variants of the target polypeptide along an isoelectric gradient.

20. The method of claim 19, wherein generating the charge variant profile for the sample further includes:
incubating the capillary in a detection antibody;
incubating the capillary in a reporter molecule; and
generating an electropherogram, wherein the electropherogram includes a plot of a strength of a signal generated by the reporter molecule versus an isoelectric point along the isoelectric gradient where the signal was detected.
